(19) United States
(12) Patent Application Publication
(10) Pub. No.: US 2017/0100738 A1
(43) Pub. Date: Apr. 13, 2017

(54) Metered Dosing Method and Mechanisms Thereof

(71) Applicant: The Werc Shop, LLC, Pasadena, CA (US)

(72) Inventors: Aaron Kendziorek, Seattle, WA (US); Nicholas Grayson Sullivan, La Canada, CA (US); Sytze Elzinga, Denver, CO (US); Bradley J. Douglass, Seattle, WA (US); Jeffrey Charles Raber, Pasadena, CA (US)

(21) Appl. No.: 14/882,018

(22) Filed: Oct. 13, 2015

(51) Int. Cl. B05C 17/01; G01F 23/02; A61J 1/22; B05C 17/005

(52) U.S. Cl. CPC B05C 17/012; B05C 17/00503; B05C 17/00546; B05C 17/00556; B05C 17/00596; G01F 23/02; A61J 1/22

(57) ABSTRACT

Enhanced metering systems for managing dosing aliquots feature cartridge housings for exchangeable cartridge with plugs for housing functional substances, extruding conduit tips with fluid flow conduits driven by advancing members for driving amounts of metered functional substance throughout the tips. Manual, pneumatic electrical and/or electronic means for advancing, combined with one way valves, viewing slots, multiple metering and dispensing ports enable two cartridge to be metered at once, as shown by graduated scales.

### FIELD OF THE INVENTION

The present invention relates to handheld dispensing apparatus and more specifically to a configuration for metered dispensing of a functional substance.

### BACKGROUND OF THE INVENTION

Metered dispensing methods are commonly used to dispense products whereby accurate delivery of a specific amount of substance is required, such as in pharmaceutical applications for dosage of a therapeutic substance. Metered dosages can be required for topical, sublingual, oral or inhalable therapeutic reasons and could further be useful in administration of specific functional formulations for non-pharmaceutical uses, such as cosmetic, food, flavor or additive uses.

Simple to use, diverse and efficient tools for dispensing metered formulations are not readily available. Simple approaches like tincture droppers, gradated syringes or general approaches like a pinch, a grain of rice, or a match head to describe the quantity are not sufficient for a large number of efficient and effective uses.

The present disclosure provides methods, apparatus and mechanisms for dispensing of substances in an accurate manner. Additionally the use of simple devices to aid in calculation of individualized dosages is disclosed.

### SUMMARY OF THE INVENTION

The present invention relates to handheld metered dispensing apparatus for quantitative extrusion of one or more functional substances. Furthermore, the present invention is intended for providing a user a relatively simple and accurate means for dosing a functional substance. A functional substance disclosed herein is intended primarily to be a composition for exposure to a person, animal, or plant by consumption or topical application: furthermore, the substance is intended to provide a function in context of biological activity or alleged biological activity. Furthermore, the present invention provides a means for exchanging a functional substance by means of an exchangeably retained cartridge for re-use of a device of the present invention for a plurality of functional substances.

### BRIEF DESCRIPTION OF DRAWINGS

FIG. 1 is a perspective view of a device assembly in accordance with the present invention

FIG. 2 is an exploded view of a device assembly of FIG. 1.

FIG. 3 is a transverse cross sectional view I of an embodiment of FIG. 1.

FIG. 4 is a transverse plan view of one embodiment of the present Invention utilizing a mechanical rotating element advancing member.

FIG. 5 is an exploded view of the embodiment of FIG. 4.

FIG. 6 is a transverse cross sectional view II of the embodiment of FIG. 4.

FIG. 7 is a detail cross sectional view 33 of FIG. 6 rotated 90 degrees from the plane of view to illustrate further detail and illustrate an interaction between a rotating element and an advanceable screw.

FIG. 8 is a top view of the mechanism housing of the embodiment of FIG. 4 illustrating depressed lobes in an annular housing feature.

FIG. 9 is a proximal perspective view of a multi-lobed pin of the embodiment of FIG. 4.

FIG. 10 is a transverse plan view of an embodiment of the present invention employing an advanceable stop mechanism.

FIG. 11 is a perspective plan view of the embodiment depicted in FIG. 10 including cartridge viewing slot.

FIG. 12 is a transverse cross sectional view III of FIG. 10.

FIG. 13 is a detail cross sectional view 64 of FIG. 12.

FIG. 14 is an exploded view of the embodiment depicted in FIG. 10

FIG. 15 is a perspective plan view of an embodiment of the present invention employing an electrically powered advancing member.

FIG. 16 is a perspective plan view of an embodiment depicted in FIG. 15 including a cartridge viewing slot in the device housing.

FIG. 17 is a transverse cross sectional view of the embodiment depleted in FIG. 15.

FIG. 18 is a detail cross sectional view 75 of FIG. 17.

FIG. 19 is an exploded view of an embodiment depicted in FIG. 15

FIG. 20 is perspective plan view of an embodiment of the present invention employing a pneumatic advancing member.

FIG. 21 is a transverse cross sectional view V of FIG. 20.

FIG. 22 is a detail cross sectional view 122 of FIG. 21.

FIG. 23 is an exploded view of the embodiment depicted in FIG. 20.

FIG. 24 is distal perspective plan view of an embodiment of the present invention housing multiple cartridges in one cartridge housing.

FIG. 25 is an exploded view of the embodiment depicted in FIG. 24.

FIG. 26 is a transverse cross sectional view of an embodiment of an SSPCRE.

FIG. 27 is a transverse cross sectional view of an alternative embodiment of an SSPCRE including a unidirectional valve.

FIG. 28 is a transverse cross sectional view of an alternative embodiment of an SSPCRE including a distal facing needle conduit.

FIG. 29 is a transverse cross sectional view of an alternative embodiment of an MSPCRE including a unidirectional valve.

FIG. 30 is a transverse cross sectional view of an alternative embodiment of an MSPCRE including a distal facing needle conduit.

FIG. 31 is a transverse cross sectional view of one embodiment of an exchangeable cartridge.

FIG. 32 is a transverse cross sectional view of an alternative embodiment of an exchangeable cartridge.

FIG. 32 is a transverse cross sectional view of an alternative embodiment of an exchangeable cartridge.

FIG. 33 is s transverse cross sectional view of an alternative embodiment of an exchangeable cartridge.

FIG. 34 is a transverse cross sectional view of an alternative embodiment of an exchangeable cartridge.

FIG. 35 is a transverse cross sectional view of an alternative embodiment of an exchangeable cartridge.

FIG. 36 is a transverse cross sectional view of an alternate embodiment of an exchangeable cartridge illustrating a variant end film type.

FIG. 37 is a transverse cross sectional view of an alternative embodiment of an exchangeable cartridge casing having a key slot.

FIG. 38 is a transverse cross sectional view of an alternative embodiment of the present invention wherein two devices of the present invention are fixed together into a single device.

FIG. 39 is a transverse cross sectional view of an alternative embodiment of FIG. 10, illustrating the functional action of the present invention.

FIG. 40 is a detail transverse cross sectional view of an embodiment of the present invention including a heating band associated with the cartridge housing.

FIG. 41 is a transverse cross sectional view of an alternative embodiment of an exchangeable cartridge casing having a tapered proximal and providing an extrusion conduit.

FIG. 42 is a transverse cross sectional view of an alternative embodiment of an exchangeable cartridge having an integral conduit tip and cartridge retaining element.

FIG. 43 is a proximal end perspective view of a cartridge having a proximal end resistive cross-slit valve.

FIG. 44 is an embodiment of the tip of the present invention.

FIG. 45 is an embodiment of the tip of the present invention.

### DETAILED DESCRIPTION OF THE INVENTION

Illustrative embodiments and exemplary applications will now be described with reference to the accompanying drawings to disclose the advantageous teachings of the present invention but in no way are meant to limit the scope of the present disclosure.

In this disclosure, relational terms such as first and second, top and bottom, proximal and distal upper and lower, and the like may be used solely to distinguish one entity or action from another entity or action without necessarily requiring or implying any actual such relationship or order between such entitles or actions. In this disclosure, the use of the term “distal” with relation to the anatomy of the present invention may be used to distinguish the end of the disclosed assembly that is at the farthest end from the extruding conduit, while the “proximal” end refers to the farthest end of the extruding conduit. However, the relates positions and orientations of components or features of a handheld metered extrusion device are described and depicted for illustrative purposes and are not required unless expressly stated. Furthermore, accessory items or other elements may be distal to the extrusion conduit in some embodiments.

In this disclosure, the term “functional substance” shall be understood to represent a chemical species, composition, or mixture thereof, which is intended to be a viscous or free flowing liquid, but may exist in solidified or near solid states when in storage under physical conditions that would alter the physical state of the composition. The functional component may be comprised of any single chemical species or combination of chemical species having desirable properties and being suitable for extrusion out of the device and suitable for use in the present invention. Furthermore, the functional substance need not be liquid, but may for example be crystalline or otherwise solid without department from the scope of the invention. The functional substance may comprise a consumable and/or pharmaceutical composition.

Furthermore, in embodiments of the present invention a cartridge may be comprised of a functional substance reservoir section, which may also be surrounded partially or wholly by a protection or otherwise functional casing. In such an embodiment, the reservoir and casing may be composed of different materials.

In embodiments of the present invention a cartridge may include a proximal and feature, which may serve to retain the cartridge to an extrusion tip section. Such a feature may include helical threads, flexible tabs, magnetic features, or any other suitable mechanism for retaining the cartridge to an extrusion tip. Furthermore, a sealing cap or protective cover may be provided to prevent exposure of the proximal end conduit section to the environment.

In particular, in accordance with an aspect of the present invention, an apparatus for metered extrusion of a functional substance is provided. The apparatus may comprise a metered extrusion of a functional substance is provided. The apparatus may comprise a metered advancing member, a housing for receiving and containing an exchangeable functional substance cartridge, an extrusion conduit, and a removably associated extrusion conduit cover. The assembly of components would be configured for extruding a particular volume of functional substance from the proximal end of the extrusion conduit.

An exchangeable functional substance cartridge, which may sometimes be termed “cartridge” or “exchangeable cartridge” herein, suitable for use with embodiments of the present invention may consist of at least a casing and a functional substance. Furthermore, the ends of the casing may be sealed completely, and where present, the casing may include open ends that may be seated for storage and shipment by removable adhered film and/or puncturable septa. Additionally, in various embodiments, a cartridge may also include a plug in one end, preferably at the distal end, which may serve as a plunger when actuated by a piston associated with a metering advancing member. In yet other embodiments, one or both open ends of the casing may be sealed with a stopper, plug, or other suitable element that would act to seal the fluid in the cartridge and prevent the influx of atmospheric gases that may cause adverse reactions with the functional substance or otherwise spoil the contents.

In additional embodiments of a cartridge, a cartridge may include a proximal section that may serve as the extrusion conduit. Preferably, the section proximal end would be of a reduced bore to provide a user ease of placement of the extruded substance at a particular location. In such an embodiment, a cartridge may also feature sealing ends and caps suitable for providing proper seal and storage conditions while not in use.

In additional embodiment of a cartridge, a cartridge may include a section or element that may serve to removably retain the cartridge to a cartridge housing or advancing member to negate the need for any other cartridge retaining element.

As an additional feature of the cartridge of the present invention, a cartridge may include a fluid control valve, such as a unidirectional valve or a valve resistive to fluid flow at its proximal end. In embodiments including a unidirectional valve, the valve would serve to prevent reverse flow of fluids into the cartridge and to retain a functional substance in the cartridge while not in use. In an embodiment including a resistive valve, preferably the valve would only permit fluid flow when an appropriate pressure is applied. In such an embodiment, the resistive valve would permit a user to exchange a cartridge whenever desired by preventing the free flew of fluid out of the proximal end. Only when pressure is applied by an advancing member would the fluid be permitted to flow through the valve. The pressure required to “crack” the valve would be obvious to one skilled in the art and would preferably be designed to accommodate ease of use and function of the present invention.

Furthermore, in embodiments of the present invention a cartridge may be manually insertable and removably retained in a housing, which in turn may be retained, supported, and/or partially or wholly enclosed by a cartridge retaining element feature or section.

Furthermore, a cartridge casing may be constructed from any suitable material, which may include, but is in no way limited to, glass, stainless steel, plastic film, brass, aluminum, ceramic or ceramic composites, plastic, polymeric composes, zinc, and coated metals such as nickel plated brass.

Functional liquids that may be advantageously contained in cartridges according to the invention include, without limitation, esters, acetate esters, alcohols, acids, lactones, carbonyls, amides, phenols, isoprenes, terpenes, thiols, saturated and unsaturated thiosulfinates, hemiterpenes, monoterpenes, sesquiterpenes, diterpenes, sesterterpenes, triterpenes, sesquarterpenes, tetraterpenes, polyterpenes, norisoprenoids, and derivatives thereof, such as terpin hydrate, a derivative of turpentine; natural flavor compounds such as those often found in fruits, including but not limited to: Gamma Decalactone, Gamma Octalactone, Butyric Acid, 2-Methyl Butyric Acid, Proprionic Acid, Isovaleric Acid, Isobutric Acid, Cinnamic Acid, Phenethyl Alcohol, Ethyl Butyrate, Ethyl Isobutrate, Ethyl-2-Methyl Butyrate, Ethyl Isovalerate, Methyl Cinnamate, Ethyl Propionate, Ethyl Hexanoate, Isoamyl Isovalerate, Phenethyl Acetate, (Z)-3-hexenal, beta-ionone, hexanal, beta-damascenone, 1-penten-3-one, 3-methylbutanal, (E)-2-hexanal, 2-isobutylthiazole, 1-nitrophenylethane, (E)-2-heptenal, furanones, 2,5-dimethyl-4-hydroxy-3(2H)-furanone, methyl 2-methylbutanoate, ethyl 2-methylpropanoate, methyl hexanoate, methyl butanoate, trans-2-hexenal, ethyl-2-methylbutanoate, ethyl butanoate, trans-2-hexenol, hexyl acetate, hexyl butanoate, 1-butanol, 1-hexanol, cis-3-hexenal, cis-3-hexeol, cis-3-hexenyl acetate, ethyl hexanoate, propyl 2-methylbutanoate, 2-methyl-1-butanol, benzyl alcohol, 1-octanol,2-phenylethanol, 1,3-oct-5(Z)-enediol, 1,3-octanediol, 4-vinylgualacol, eugenol, 2-methylbutanoic acid, 4-hydroxyphenylacetic acid, 3-hydroxy-beta-damascone, 4 hydroxy-3-methoxyphenylacetic acid, 3-oxo-alpha-ionol, vomifoliol, 3-oxo-β-ionol, dehydrovomifoliol, roseoside; and/or natural flavor compounds such as those found in vegetables, including but not limited to: dimethyl sulfide, thiosulfinates, disulfides, poly-sulfides, 2-propene-1-sulfinothioic acid S-2-propenyl ester (allicin), methanesulfinothioic acid S-2-propenyl ester, 2-propene-1-sulfinothioic acid S-(E,Z)-1-propenyl ester, 2-propene-1-sulfinothioic acid S-methyl ester, Linoleic acid, (E)-2-nonenol, (E)-2-nonenal, (Z)-3-nonenol, (Z)-3-nonanal, C9 Carbonyls, (Z,Z)-3,6-nonadienal, (E,Z)-2,6-nonadienals 3-methylbulanoates, 2-phenthyl esters, 2-phenethyl 3-methylbutanoates, (E)-2-hexenyl 3-methylbutanoate, benzyle 3-methylbutanoate, (E)-2-hexenyl 3-methylbutanoate, benzyl 3-methylbutanoate, methyl 3-methylbutanoate, butyl 3-methylbutanoate; 3-methylbutanoate, butyl 3-methylbutanoate, 3-methylbutyl 3 methylbutanoate, (E)-2-pentenyl 3-methylbutanoate, 2-phenethyl hexanoate, sesquiterpene alcohol, cubenol, phthalides, 3-butylphthalides, 3-butuyl-4,5-dihydrophalide, cis and trans forms of 3-butyl-3a,4,5,6-tetrahydrophthalides, (Z)-ligustide, 1-(E,Z)-3,5-undecatriene; sesquiterpene hydrocarbons, alpha-copane, alpha-muurolene, alpha-calacorene, cadinenes, 2-acetyl-1-pyrroline, 2-ethyl-3,6-dimethylpyrazine, acetaldehydes 3-methylbutanal, 4-vinylgualacol, 2-acetylthiazole, 2-acetyl-2-thiazoline, 2-(1-hydroxyehtyl)-4,5-dihydrothiazole, 2,5-Dimethyl-4-hydroxy-3(2H)-furanone, hydrogen sulfide, methanethiol; ethanethiol, octa-1,5-dien-3-one, linalool, (E,E)-deca-2,4-dienal, p-mentha-1,3,4-triene, myrcene, 2-sec-butyl-3-methoxypyrazine, myristicin, (E,E)-deca-2,4-dienal, (Z)-dec-6-enal, Beta-phellandrene, (Z)-hex-3-enal, (Z)-hex-3-enol, (Z)-hex-3-enyl acetate, vanillin, menthol, methyl salicylate, 3,7-gualadiene, delta-cadinene, cannabinoids, nicotine, caffeine, citicoline, and taurine. The current invention may also employ the vast array of melanoidins, a class of chemicals produced by Maillard reactions, wherein amino acids and reducing sugars are heated together to produce complex compositions of chemicals derived therefrom. In addition, Alkaloids, steroids, indoles, diazepines, pharmaceutical formulations, therapeutic formulations, biologies, protein solutions, recombinant protein solutions, amino acid polymers, natural or recombinant/synthetic deoxyribonucleic acid polymers, natural or recombinant/synthetic ribonucleic polymers, solutions of naturally derived or recombinant single or double stranded RNA solutions, solutions of natural or recombinant plasmids, natural or recombinant/synthetic cosmids, viruses, bacteria, fungi, protists, algae, prions, or other microorganisms, particles, organelles thereof, extracts from plants, including essential oils, and/or other biological or biologically active components and materials may be utilized.

### Cartridge Housing

The present invention includes a cartridge housing for housing and/or retaining at least one exchangeable cartridge. As a further aspect of the cartridge housing, the housing may serve as anchor for cartridges, cartridge retaining elements, metered advancing members, or other features of the present invention that would interact with the exchangeable cartridge. In various embodiments, the housing may integrally contain an entirety or portion of certain elements of the present invention, such as an extrusion conduit or an advancing member.

In one embodiment of a cartridge housing, the cartridge housing includes a proximal opening for receiving an exchangeable cartridge and a distal end for interfacing with or being integral with a metered advancing member. Furthermore in such an embodiment, a removably fixed cartridge retaining element would exist at the proximal end to retain the cartridge in the housing. In a similar but alternative embodiment, a cartridge having at least an integral extrusion conduit tip and housing anchoring element may be removably retained by the housing at its proximal end.

In an alternative embodiment of a cartridge housing, the cartridge housing may receive a cartridge from its distal end at a distal opening. Furthermore, in such an embodiment, the cartridge would be retained by a removably fixed distal cartridge retaining element which may comprise a metered advancing member or an adaptor to a metered advancing member. In such an embodiment, the housing may include internal features at its proximal end for retaining the cartridge inside the housing, or may alternatively accept a removably fixed cartridge retaining element at its proximal end. The proximal retaining element may interact with the cartridge to aid in retaining it in the housing, or alternatively an extrusion conduit may simply be removably or permanently fixed to the housings proximal end and would only serve as a fluid flow conduit. Furthermore, in various embodiments and assemblies of disclosed elements, the cartridge housing may be constructed to accept a cartridge from either its proximal or distal end.

As a further aspect of the previously disclosed features of extrusion conduit tips, SSPCRE, and MSPCRE, an extrusion tip or assembly in general may include a feature for exchangeably fixing a proximal end feature of an exchangeable cartridge to the extrusion tip. In such an arrangement, the exchangeable cartridge could be fixed to the extrusion tip, resulting in a tip/cartridge complex which could then be inserted and exchangeably fixed to the cartridge housing. Any suitable anchoring mechanism could be employed, where for example, a threaded feature of the extrusion tip body or assembly body.

In an additional embodiment, a cartridge housing may be composed of a housing structure and a heating jacket or element to surround a cartridge or be in contact with a cartridge in such a way to deliver heat energy to the functional substance retained in the exchangeable cartridge.

In yet an additional embodiment a cartridge housing may be composed of a housing structure or be associated with an element thereof that may be heated via an outside heat source, such as a microwave, which may infuse a notable abundance of heat energy into the housing itself or the element so as to extend the warmed state of a cartridge installed in it previously or thereafter. Furthermore, in an embodiment employing a specific element for retaining a large portion of heat, the material would preferably consist of a substance capable of retaining a significant amount of heat.

As a further aspect of embodiments of cartridge housings, a cartridge housing may include a visible graduated scale on its exterior to communicate to the user a particular measurement in relation to the amount of functional substance extruded by the device. Furthermore, to aid in the visualization of the contents of the exchangeable cartridge, a housing may include a viewing port in its side, such as a slot. Alternatively, the housing may be constructed from a visibly clear material, such as polycarbonate plastic, that would permit the viewing of its contents. In such an embodiment, a graduated scale may also be included and may be printed on an interior or exterior surface.

As a further aspect of conduit tips including valves, the valve may be arranged to be positioned at the most proximal extent as possible, so that upon extrusion the valve may help retain excess fluid flow from the conduit and prevent extrusion of too much material. Furthermore, in such an arrangement, the valve may be removeably retained by a protective cover that is also removeably retained. An example of such an arrangement would be a protruding proximal conduit tube section, which could retain a valve having a sleeve section that fits over the end of the tube. Furthermore, the arrangement could be made to receive a removeably retained cap, having an axial through hole, that covers and prevents the valve from be pushed off the end of the tube while still permitting flow of the extrudate from the valve. Such an assembly would advantageously permit a user to install a flew control valve directly at the point of extrusion so as to minimize unwanted excess flow from the conduit tube after the extrusion event.

When an apparatus according to the present invention includes a cartridge that has integrated into it an extrusion conduit tip, the cartridge may be removably retained to a cartridge housing by a retention element that serves only to lock the cartridge into the housing. The element may comprise an annular object that may be threaded or otherwise made to be able to anchor to a cartridge housing and claim or otherwise fix a cartridge in place. In an additional embodiment, a cartridge having a housing retention element integrated into the cartridge could similarly have an anchoring mechanism to retain the cartridge into the housing but would not require any auxiliary parts to retain it to the housing.

### Proximal Cartridge Retainers

When an apparatus according to the present invention includes a proximal cartridge retaining element, the cartridge retaining element may comprise a single section or two or more separate sections removably or irremovably connected together. In any proximal cartridge retaining element embodiment, the element as a whole would serve to at least retain an exchangeable functional substance cartridge in or to a cartridge housing and in some embodiments may also provide a fluid flow conduit through the body from its axial end to end that may or may not be interposed by other functional elements, such as valves or other features.

### Proximal Cartridge Retaining Element Single Section

When an apparatus according to the present invention includes a single section proximal cartridge retaining element, alternatively termed “SSPCRE” herein, the element would be composed of at least a feature at its distal end for connecting to a cartridge housing at the cartridge housing's proximal end, a fluid flow conduit from its axial end to end, and may or may not include various features or elements provided in-line with the fluid conduit. Furthermore a SSPCRE would contain a fluid flow conduit from end to end made to be in fluid communication with a functional substance retained in an exchangeable cartridge and a pod or orifice at its proximal end for permitting the extrusion of functional substance out of the proximal end of the assembly thereof. Furthermore, the single section proximal cartridge retaining element may also house other elements such as unidirectional valves, heating elements, or other functional elements interposed between the SSPCRE and the cartridge housing. Furthermore, the SSPCRE may also partially house one end of the exchangeable cartridge if the cartridge protrudes from the cartridge housing to some measurable extent. As an additional feature, the SSPCRE may have a tapered needle section around the fluid flow conduit at a distal position for puncturing a septum and/or film on the end of an exchangeable cartridge. Furthermore, the SSPCRE may contain a septum or septa for accepting a needle from an external device for refilling a housed exchangeable cartridge or for accepting fluid flow from the present invention. As a further feature, the SSPCRE may contain a heating element, such as a resistive coil or any other suitable heating element. As yet an additional feature, the structure of the SSPCRE may include geometrical features, such as slots, electrical contests, or other features that may allow it to interface favorable with external devices or objects. As a whole, the SSPCRE would function to retain an exchangeable cartridge, provide a fluid flow path for extrusion, provide a heat source, and may also provide other features for mating with external devices or present fluid reverse flow by way of unidirectional flow control.

### Proximal Cartridge Retaining Element Multiple Sections

When an apparatus according to the present invention includes a cartridge retaining element comprised of multiple sections, alternatively termed “MSPCRE” herein, the element assembly would have at least at the distal end of the assembly a feature, or section, or feature of a section for removably connecting to a cartridge housing's proximal end. Furthermore the element would include a fluid flow conduit from end to end in fluid communication with the functional substance retained in an exchangeable cartridge and an open end of the fluid flow conduit at the proximal end of the assembly of sections that would permit the extrusion of the functional substance at a particular location exterior to the proximal end of the present invention.

In one embodiment of a MSPCRE consisting of two distinct sections, the two sections would compose a first cartridge retaining section for connecting with a cartridge housing, retaining an exchangeable cartridge, and establishing fluid communication with a functional substance. The second section proximal to the first would function as an extended extrusion conduit tip having an open ended fluid flow conduit through its core. Furthermore, in alternative embodiments, interposed between the two sections or integrated with one or both of the sections would also be additional features, elements or sections that may provide other desirable functions, such as unidirectional flow, a distinct housing section for a unidirectional valve, a septum, a flow restrictor, a heating element, an adaptor for rapidly exchanging extrusion conduit tips, or any other feature or element that may enhance the function of the apparatus. Furthermore, the MSPCRE may be composed of multiple sections, which may collectively compose any portion or feature of previously disclosed embodiments or features of extrusion conduits tips or single section proximal cartridge retaining elements.

Asmospheric Exposure Reduction

As a further elaboration of the previously disclosed features of extrusion conduit tips, SSPCRE, and MSPCRE, the elements may provide a system for reducing atmospheric gas exposure by including a reduced diameter object, a puncturable septum, and/or include a unidirectional valve that would permit flow of functional substance out of the exchangeable cartridge, while also preventing influx of atmospheric gases into the cartridge. In embodiments employing a puncturable septum, the septum would preferably consist of an elastomeric and/or polymeric film or series thereof, which could be punctured by a conduit needle. Furthermore, preferably the septum material would consist of chemical resistant materials, which could also be used in applications for food goods exposure. Exemplary materials are silicone, PTFE (Polytetrafluoroethylene), Viton©, Nylon, PEEK (Polyether ether ketone), and BoPET (Biaxially-oriented polyethylene terephthalate), but would not be limited to such materials. In all cases, one skilled in the art would recognize appropriate materials, applications, and uses thereof.

Furthermore, Embodiments of such elements employing a unidirectional valve may utilize any suitable valve, but for example could employ duckbill, umbrella, umbrella/duck combinations, cross slit, dome, or ball valves. Preferably the valves would consist of chemically resistant and food exposure suitable materials such as silicone, fluorosilicone, fluoroelastomer, natural rubber polyisoprene, butyl, ethane propylene, nitrite, or any other suitable material, but would not be limited to such materials. In all cases, one skilled in the art would recognize appropriate materials, applications, and uses thereof.

### Distal Cartridge Retaining Elements

In accordance with the present invention in certain embodiments, a cartridge housing may have an opening at its distal end for receiving an exchangeable cartridge and a cartridge retaining element for retaining the cartridge in the housing. In such an embodiment, the cartridge retaining element may be a composition of a retaining element and a metered advancing member or simply a cartridge retaining element that may be at the distal end of the assembly or interposed between the housing and the metered advancing member.

### Proximal Cap

As an additional aspect of the present invention, preferably the device would be provided with a removably retained proximal cover, alternatively termed “proximal cap” herein. The proximal cap would be located proximal to the extrusion conduit element and would serve to cover the exposed end of the extrusion conduit to further prevent atmospheric exposure, contain accidental leaks, prevent damage to the conduit, prevent possible injury that could arise from a stabbing with a reduced end of the extrusion conduit, or be provided for general storage and aesthetic purposes. In embodiments having multiple extrusion conduits, multiple proximal caps may be provided.

### Metered Advancing Members

In accordance with the present invention, a cartridge housing would include or have associated with it a metered advancing member. Such a mechanism would interact with an exchangeable functional substance cartridge at its distal end by driving a piston or screw into or otherwise actuating or compressing a functional substance out of the exchangeable cartridge at its proximal end. Furthermore, the advancing member would preferably include a metering capability that would allow a user to advance the actuation a desired quantity either by visual indication, by tactile feedback, or by both simultaneously. Furthermore in various embodiments, a metering advancing member may include visible graduation scales to indicate to a user advancement distances and cartridge content volume. Additionally, the advancing piston, screw, or other suitable element may have a permanently associated plunger plug for driving the functional substance out of the exchangeable functional substance cartridge or otherwise may Interact with a plug pre-installed in a cartridge to provide the same result.

A metered advancing member of the present invention would function to drive the flow of functional substance out of the exchangeable cartridge in a metered and controlled fashion. In all embodiments of a metered advancing member, the advancing members would act on the distal end of an exchangeable cartridge, apply a pressure to a retained substance with a plunger, and force functional substance out of its proximal end. Alternatively, when a cartridge is employed that has a casing made of a flexible substance of film, an advancing member may progressively squeeze the casing to force extrusion out of the cartridge, such as with a plate or with rollers.

In accordance with the present invention, a metered advancing member may be comprised of any suitable mechanism that performs the intended function of the present invention. In particular, several embodiments are described in detail herein, but it should be appreciated that many alternatives and mechanistic designs and features thereof, such as electrical elements, are contemplated and envisaged and one skilled in the art would recognize that the mechanisms and features disclosed herein in generality can be extended to other variations without departing from the scope of the present disclosure.

Furthermore, in various embodiments, metered advancing members disclosed herein may be coupled or combined with any other features of the invention either in part or in whole, such as cartridge housing, attachment adaptors, cartridge retaining elements, or other features disclosed herein. For example, a mechanism housing may be combined with a cartridge housing to comprise a single part. Additionally said advancing members may optionally be controlled through wireless communication mechanisms.

### Mechanism Disclosures

### Simple

In one embodiment of a metered advancing member, the metered advancing member would consist of a mechanism housing, a plunger rod, a finger grip, and a housing distal end cap. In one embodiment, the mechanism housing may be combined with a cartridge housing, to represent a single part, and may with its interior bore slidingly engage with a finger grip attached to a plunger rod, the plunger rod alone, or both simultaneously. Together the finger grip and rod would maintain axial alignment inside the housing to allow the plunger rod to interact with the exchangeable cartridge and actuate flow of the functional substance. Alternatively, the finger grip would be associated with the plunger rod and the plunger rod would slidingly engage with an annular slot interposed between the cartridge and the advancing member that would maintain the plunger rod in axial alignment with the cartridge. In all variations, the mechanism housing would provide a slot for the finger grip to pass through, which would also be abutted by a graduated scale marked on the visible exterior surface of the housing to indicate the relative position of the plunger and advancement distances possible or already performed. Additionally, in both cases, preferably the distal end of the housing would have a cover or cap that may be permanently or removably retained to permit the initial construction or intermittent deconstruction of the assembly. In an alternative embodiment, a similar arrangement could be provided whereby a tactile feedback mechanism would be included wherein a portion of the finger grip would interact with raised or recessed features in series along the length of the slot and as the finger grip is forced through the slot, the element of the finger grip, which for example could be a spring metal flange, would form a resistive contact with the slot features as each feature is passed. Such a mechanism could be used to indicate the advancement of a defined distance that corresponds with a defined volume of functional substance extruded. In all embodiments, preferably the sliding action of the rod would be accompanied by a moderate resistance to movement so the rod does not slide freely back and forth without force generated by a user's hand.

### Screw an Click

In an alternative embodiment of a metered advancing member, the metered advancing member may comprise a screw-driven plunger and an element rotated by a user to drive the screw plunger. In embodiments utilizing a screw-driven plunger or plunger rod, the screw may be driven by rotating action provided by a used in various embodiments, the advancement of the screw may be accompanied by a tactile feedback, such as a clicking action. Furthermore in various embodiments, the advancing distance may be preset or adjustable by the user.

Furthermore, in one embodiment, the advancement of a said plunger screw could be provided by a user driven rotating element that does not become displaced in the proximal or distal direction, but rather would only rotate in position about its axis. This could be achieved by employing a plunger with, for example, a square-like or rectangular-like shaft having two flat faces, and two externally threaded radial faces. With such an arrangement, the shaft could be rotated by a user's manual rotational of the rotating element, which would apply force on the shaft's flat faces while the threads simultaneously interact with a stationary threaded hole in the housing, causing the screw to advance along its axis in accordance with the pitch of the helical thread. Furthermore, the manually rotated element would permit the shaft to slide through its body along the fiat faces as the screw advances. In such an embodiment, the manually rotated element may be visibly clear and may have on it printed a graduated scale, which could be situated circumferentially around the rotated element, which would coordinate with the position of the distal end of the screw shaft to indicate to the user the position of the screw in relation to the cartridge.

Furthermore, in an additional embodiment, the manually rotated element may have associated with it a composition of elements that may provide a tactile feedback when the manually rotatable element is rotated to indicate a certain advancement of the element. In one embodiment, the manually rotatable element may retain a length of spring metal sheet or wire with a radially protruding tab or bend that would interact with an interior diameter slot of a hollow cylindrical housing. In such an arrangement the spring metal tab would interact with a series of raised features of the slot to cause a resistance to rotation and a “click” like tactile feedback.

In an alternative embodiment, a resistance to rotation and a “click” like tactile feedback could be provided by rotational coordination of a manually rotatable element with a multi-lobe pin with protruding lobes having a hole bored through its center to permit the free passage of a dual flat-sided advancing screw. Furthermore, the multi-lobed pin would be arranged to be forced into and interact with matching arrangement of recessed lobes. In an annular section of the mechanism housing, which would also have located at its center a threaded hole for mating with the advancement screw. Furthermore, as a final feature, the multi-lobed-pin would be forced into the recessed lobes with a metal spring backed up against a slot in the manually rotatable element. In concert, as the manually rotatable element is rotated, the multi-lobed pin is forced to rotate with it and is forced up the recessed lobe ridges and out of the recessed lobe depressions. As the pin is forced upward, and rotates over a lobe ridge, it presents a resistance to rotation and slidingly advanced toward the distal and of the assembly in a slot provided for its travel. Once the rotation has permitted the multi-lobed pin to fall back into the recessed lobe depressions, the force of the spring causes it to snap back into the recessed lobes. As a result the process causes a “click” like tactile feedback to the user rotating the element. In such an embodiment, the manually rotatable element may also feature a visible scale to coordinate with the advanceable screw position. Furthermore, in such an embodiment, the rotation could occur in either direction, permitting a user to return the screw to a fully retracted position, allowing the replacement of the cartridge.

As a further aspect of the embodiments of a metered advancing member wherein a tactile feedback feature would be employed, the mechanism may employ a “click” tactile feedback that would indicate the actuator advancement of a predetermined amount or an amount selected by a user. The term “click” infers either the generation of a unique sound, tactile feedback, or both simultaneously. Furthermore, in the preferred embodiment, the advancement of the mechanism would also be able to be visually Indicated to the user as a quantity or advancement along a graduated scale.

For the generation of a tactile feedback associated with an advancement, a variety of mechanisms could be employed to achieve the function. In one embodiment, the depression of an element associated with the mechanism could be utilized to cause a short and preset advancement of the actuator by driving a piston or screw or short distance or rotation. Furthermore, in such a mechanism the element depressed would return to its original position to permit additional advancements. Such a mechanism would appear similar to a retractable ink pen.

### Advanceable Stop Mechanism

In other embodiments of a metering mechanism, the mechanism may comprise a depressible piston limited by an advanceable stop. In embodiments employing these elements, the stop block would preferably be advanceable toward the proximal end of the assembly and housed within it would be a depressible piston. In such embodiments, the advancement of the stop would preferably not engage with the depressible piston whilst advancing and would remain in its original position until acted upon and depressed by a user. Functionally, the interdependent association between the two elements would permit a user to advance the stop a desire distance before driving the piston and the subsequent extrusion of a functional substance out of the exchangeable cartridge at its proximal end. Once a user would like to depress the piston and expel the functional substance, the user would apply pressure to the distal end of the piston—depressing it until contact is made with the stop. The stated mechanism and process would permit a user a select a volume of functional substance to expel, then expel the volume in a single rapid event.

In one embodiment of the present invention, an advancing member consisting of an advanceable stop and a depressible piston may comprise an assembly wherein an advanceable stop may consist of an axial bore and an internal helical thread engaged with an external helical thread on the distal end of a cartridge housing, whereby the rotation of the advanceable slop would cause a traversing of the cartridge housing, whereby the rotation of the advanceable stop would cause a traversing of the cartridge housing. Preferably, the advanceable stop would be assembled in such a fashion that upon reaching the ends of travel the advanceable stop would be halted. Most notably, by limiting the travel a user would not be inconvenienced by unintentionally disengaging the threads when unscrewing the part at its end of travel at the distal end of the cartridge housing. This may be achieved by use of snap rings during manufacturing assembly or by other features of the two components. Where used, a snap ring may consist of a ring having open and disconnected ends that are partially recessed to permit the partial compression of the ring toward its axial center. In various embodiments, the ring may consist of a wire of various profiles formed into an annular structure or may be a ring produced by stamping. The wire profile may be round, square, triangular, or any other geometry that may serve the halting function and would not be limited to such profiles. Furthermore, in such an embodiment, preferable the stop block could be advanced in the distal-to-proximal direction or proximal-to-distal, herein the later would permit a user to exchange an exhausted functional substance cartridge with a new cartridge.

In embodiments employing an advanceable stop and a depressible piston preferably the advancing member would have associated with it a visible indication of position and advancement distance. Visible indication could be provided by a graduated scale, multiple scales, or multiple graduated scales visibly interacting with one another to indicate a position. In embodiments employing a single graduated scale, the scale would preferably be located on a visible section of the apparatus and may be partially or wholly covered or made not visible as the advanceable stop is moved—thus indicating the advanced distance or distance still available for advancement. Multiple scales may be employed in a single assembly of the present invention wherein one scale may indicate different a graduation scale than the other. For example, one scale may indicate a mass as milligrams, while another may indicate a volume as milliliters.

In one embodiment, a pair of graduated scales may interact visibly with one another to indicate an advancement. For example, a scale spanning a proximal-to-distal axial length would be marked on a visible surface, such as the outer surface of the cartridge housing, whilst a scale marked on the outer circumference of an advanceable stop may exist toward its leading proximal edge. In such an embodiment, the advanceable stop would partially surround the marked cartridge housing and would engage with a helical thread on the housing. Rotation of the advanceable stop would cause it to traverse a length of the housing and consequently the scale marked on the housing. Together, the rotating scale marked on the advanceable stop would Indicate a factional advancement of a graduation on the scale marked on the housing as rotation occurs. For example, the engaged thread may have a pitch of 1 mm and the graduations on the housing may be interspersed by a 1 mm distance. A full (380-degree) rotation by a user would cause the advanceable stop to traverse 1 mm of the housing, but it may be that a user would like to be able to traverse a smaller distance while still having available a finer graduation to indicate the resultant displacement caused by a partial rotation. In such an arrangement, the finer graduations would be marked on the visible surface of the advanceable stop and would coordinate with a marking on the cartridge housing to provide indication of the displacement resulting from a partial rotation.

In further embodiments of the present invention employing an advanceable stop and a depressible piston, the advanceable stop may include a tactile feedback mechanism or frictionally resistant element to indicate to the user a certain displacement of the advanceable stop. In an embodiment employing a rotation advanced stop, a functionally resistant or click type of tactile feedback may be employed to indicate the displacement of the stop in relation to a full or partial rotation.

In additional embodiments of metering advancing members, various embodiments may include an electronically driven and controlled actuation of the advancing piston. In such mechanisms, an electronically controlled actuator would preferably be able to be controlled by a user by interaction with buttons or other control interfaces associated with the housing. Electrical actuation may be driven by a motor or a solenoid. Further embodiments of electrically driven actuation may be wirelessly linked to a controller using a human interface.

In embodiments comprised of an electronic motor driven actuation mechanism, the system would preferably be comprised of a user interaction interface, an electronic control circuit, a battery, an electronic motor, a power transfer system, an advanceable piston, and a housing.

As a further aspect of a user interaction interface, the interface may simply be a single button or switch, or may comprise multiple buttons, keypads, or other switch elements that would be in electrical communication with the electrical control circuit. Furthermore, a user interaction interface may include a display screen controlled by an electronic control circuit. Additionally manual switches or buttons may comprise any type of mechanical switch, such as a push button, or a slider, twist knob or collar; or an electromechanical switch, such as a touch screen or other touch sensor which may for example be comprised in a display/control panel or wirelessly connected.

As an additional aspect of the present invention with respect to the present embodiment, a selectively engageable thread system may be employed to permit the user to slide the advanceable stop along its axis without rotation until the user chooses to engage the helical thread that is used to advance the advanceable stop when selecting a volume of extrudate to extrude. Such a composition would function by mechanically engaging or disengaging the helical threads of the cartridge housing and the advanceable rotatable element. For example, in such a case, the cartridge housing section may include a plurality of threaded blocks that can be retracted away from or extended out to the point of engagement. In one embodiment, the cartridge housing would be arranged to have an array of radial slots for housing radially extendible blocks, each having a single outwardly projecting helical threaded face. The blocks may be extended and retracted through any suitable mechanism, where for example, in the case of three blocks, a lobed cam may be positioned below the blocks toward the center axis where the lobed cam is rotated by the plunger pin. The blocks may be retained toward the center axis and into their housing slots by a circular spring, such as a garter spring or end connected extension spring. In such an arrangement, the lobes of the cam would be designed to force the blocks outward radially to an extent that their threaded faces would become engaged with the internal thread of the advanceable rotatable element of the advanceable stop. While in this state, the threads would be engaged and rotation of the advanceable stop would cause a translation across the cartridge housing with respect to the pitch of the helical thread. When a user would like to disengage the thread to retract the advanceable stop to a new position to avoid inconvenient screwing action, the user could twist the plunger pin, causing the blocks to retract to the lower section of the lobed cam, become disengaged with the thread, and release the advanceable stop from the thread. Reengaging the thread could be performed by once more rotating the plunger pin to a position where the lobes push the blocks back out to a point of thread engagement.

In one embodiment, the control circuit includes a memory storage element capable of recording and storing usage data relevant to the user, as well as any other information delivered to the device by means of electrical communication by either a direct wire connection or a wireless communication mechanism. This data may include, for example, cumulative consumption of the functional substance over a given time period; volumes of functional substance use by the user; time periods between uses; temperature profiles of one or more components; power consumption history; stored preferences or settings; and alternate modes of use, such as previous combinations of components connected in the device assembly, and in what order they were connected, and/or particular encoded information identifying attributes of a component, such as its pad of serial number, a flavor or substance that it contains or may contain, for example. Furthermore, the data stored may be used by processing units to control the mechanisms of the present invention. One skilled in the art will appreciate that these types of data are disclosed by way of example and should not be considered to limit the scope of information that may be stored in the memory storage element within the scope of the invention.

Preferably, an electronic controller includes one or more processing elements/processors. For example, the processors could be used to determine what is displayed on display/control panel and/or to actuate automatically advancing members or elements in accordance with data and logic processed by the processors. One skilled in the art will appreciate the diverse extensions of the use of processors in the present invention, which are by no means restricted to the processing examples disclosed herein.

As an alternative to simple manual actuation, actuation of an advancing member may occur automatically in response to the input of a passcode matching a valid passcode stored in a memory of a controller. Alternatively, a correct passcode entry may only “unlock” the advancing function of the device, without automatically initiating advancement, but instead permitting a user to actuate advancement manually. For instance, after the passcode is successfully validated, a user may press a simple button or switch to initiate actuation. The atomization element may respond to a single manual actuation following passcode validation, a predetermined plural number of manual actuations, for a predetermined amount of time elapsed after passcode validation, or until the processor receives an affirmative user command to “lock” the device again, such as by re-entry of a passcode to toggle back to a locked state, or by a simple manual switch or button. The password may be input by a user directly into display/control panel or communicated to controller from a separate input device or token, such as a user's personal smartphone, magnetic key card, bar code image, via a Wi-Fi, infrared, Bluetooth®, RFID, or optical connection, for example.

In one embodiment, the controller may also include or be operatively linked to a wireless communication element (not shown in figures) capable of transmitting to another wireless communication device or receive information from said wireless communication device. In general, many wireless network types are contemplated in this disclosure and may include, but are not necessarily limited to WPAN (Wireless Personal Area Network), WLAN (Wireless Local Area Network), WAN (Wide Area Network), or any other suitable wireless network and communication types. Advantageously, wireless network connectivity enables dispensing devices according to the invention to communicate with or be controlled by a personal electronic device such as a smartphone, for purposes of passcode-enabled actuation or locking/unlocking of one or more functions of the dispensing device (obviating the need for a multi-key user interface on the inhalation device itself), as well as facilitating monitoring/tracking, storage, and analysis of usage data on the personal electronic device.

Furthermore as an additional aspect of the electrical control circuit, preferably the circuit would be designed so as to be able to receive and transmit to a battery or a heating element an electrical current from a charging lead, as well as including electrical communication elements for transmission of data between device 130 and external computation and/or data storage devices. In one embodiment, a connection port (not shown in figures) at the proximal end of a batter/controller housing or at the extrusion conduit can be mated with other elements extending proximally or distally therefrom. When included, such a connection port may also permit electrical communication from the circuitry to one or more actuation mechanisms.

As a further aspect of the present invention, the cartridge housing or advancing member may have associated within it a scanner or sensor for detecting a datum or data from an exchangeable cartridge or other object that may then be displayed to a user on the device with an electronic display or used by the electronic control circuit to alter the actuation in accordance to the data received.

Advantageously, electrical controller may be designed to regulate battery charge rate with respect to voltage and current and could prevent battery overcharge. Furthermore, preferably the electrical control elements would prevent reverse polarity damage to the circuit elements or battery, by incorporating appropriately configured elements such as diodes, PNP Transistors, or a P-channel FET.

As a further aspect of an electronic motor for use in various embodiments, the motor may be driven by alternating or direct electrical current and would be in electrical communication with a control circuit. In a very simple embodiment, an electrical control circuit may simply comprise an electrical communication between the motor and a battery, interposed by a current switch. In more advanced mechanisms, the control circuit may comprise other features disclosed herein and also be in electrical communication with the electrical motor. Furthermore, in an alternate embodiment, the advancing member may include multiple electrical motors.

As a further aspect of a power transmission assembly, the power transmission may compose a series of spur gears, worm gear, helical gears, planetary gears, or any other suitable gears for transfer of rotational force from an electrical motor to an advancing piston. Alternatively, in an additional embodiment, a belt driven or frictional clutch systems may employed.

### Pneumatic System

In an additional embodiment of a metering advancing member, a pneumatic system may be employed by use of a portable compressed gas container in association with an advancement mechanism. In such an embodiment, gas pressure provided by an onboard pressure reservoir, such as a compressed carbon dioxide gas cartridge/tank, which may be exchangeable or integrated and reliable, could be used to drive a pneumatic cylinder piston. In one embodiment the compressed gas tank may be exchanged through a port on a distal portion of the device housing or a proximal portion of the device housing. In yet another embodiment, the compressed gas tank may be exchanged through a hinged door or sliding door on the side of the device housing. In an additional embodiment, the device housing may have a slot permanently cut out of the side of the device housing to permit the exchange of the tank from the side. In all embodiments, preferably the exchangeable tank would mount dependably in a position and relation with a valve assembly so as to prevent excessive gas leak out of its connection points where pressurized gas is made to be in fluid communication with the device or elements thereof.

In various embodiments of a pneumatic embodiment of the present invention, the piston would drive a plunger rod for actuating the flow of functional substance out of a cartridge. In embodiments employing a pneumatic cylinder, a single-acting, double-acting, or telescoping cylinder design could be employed as well as cylinder arrangements having a return spring to cause the piston to return to a home/starting position when pressure is not provided. Actuation of the pneumatic piston would preferably be controlled with a valve mechanism that would be interposed between the pressure reservoir and the pneumatic cylinder. Furthermore preferably the valve assembly would permit a user to change the flow rate and pressure delivered to the cylinder and also include a switch, such as a depressible button to allow a user to actuate the flow manually. In an alternative embodiment, a screw driven by a rapid flow of compressed gas through a turbine or other analogous element could be used to advance a screw driven actuator. In yet an additional embodiment, the valve assembly may accept a pressurized gas or other fluid from an external line, such as a gas line from an air compressor.

In an additional embodiment of the present invention, a cartridge housing may comprise multiple cartridge retaining sections, so as to permit the containment of multiple exchangeable cartridges in a single housing. Furthermore, in such an embodiment a single advancing member may be employed to operate functionally with multiple cartridges individually or simultaneously. In such an embodiment, the mechanism would require an additional mechanism for moving the advancing member to each cartridge. In one embodiment a cartridge housing may contain multiple cartridges distributed in a radial array fashion, whereby a single advancing member may be advanced from one cartridge to the next by radially rotating the mechanism from one cartridge to another along the cartridge distribution array pattern. This may be achieved by appending an advancing member to a center spindle that would permit the advancing member to reach each cartridge of rotated to the cartridge location.

In an alternative embodiment, a multi-cartridge housing may be employed that is operated upon by multiple advancing members associated with one or more cartridges.

Furthermore in an alternative arrangement, multiple individual cartridge housing advancing members may be fixed together into a single unit by an adaptor or other element that may fix them together into a single multi-operational unit.

In an additional embodiment, a plurality of cartridges may be arranged in such a way that functional substance extruded from each cartridge may be combined in a shared flow path to provide convenience to a user and/or facilitate in-situ mixing of substances prior to final extrusion from the present invention. In one embodiment, a user may choose to extrude a single substance at once, or alternatively a user may mix two or more functional substances together via an element of the present invention prior to final extrusion. In one embodiment, a single gauge may be used to operatively select the volume of extrudate from each of multiple cartridges. In another embodiment, multiple meters may be employed to provide a user with the ability to select a particular volume of extrudate from each cartridge. In yet another embodiment, a mechanism may be employed whereby extrusion rate and amounts may foe controlled individually for each cartridge simultaneously. In such an embodiment an electronically driven or pneumatic advancing member may be employed to provide selective control of extrusion rates from each of multiple cartridges. In one embodiment, a proximal cartridge retaining element may provide facility and/or conduit for mixing of multiple substances and final extrusion. In other embodiments, the proximal cartridge retaining element may be composed of multiple sections or elements. Furthermore, in alternative embodiments, cartridges may be retained by distal elements and mixing and/or mixing mechanisms may exist as integral features of cartridge housing or housings.

As a further aspect of all the embodiments disclosed herein and envisaged within the scope of the present invention, the materials of which the components would preferably be constructed with may comprise hard materials, such as metals and plastics, opaque or clear substances, such as colored or optically clear plastics or glass. Furthermore, one skilled in the art would recognize proper material choices for various embodiments and variations thereof and no component should be limited in any way to a certain material of construction or way of manufacture.

### DETAILED DESCRIPTION OF DRAWINGS

In accordance with aspects of the present invention, various embodiments of the present invention and its components will now be described in greater detail in reference to figures and drawings.

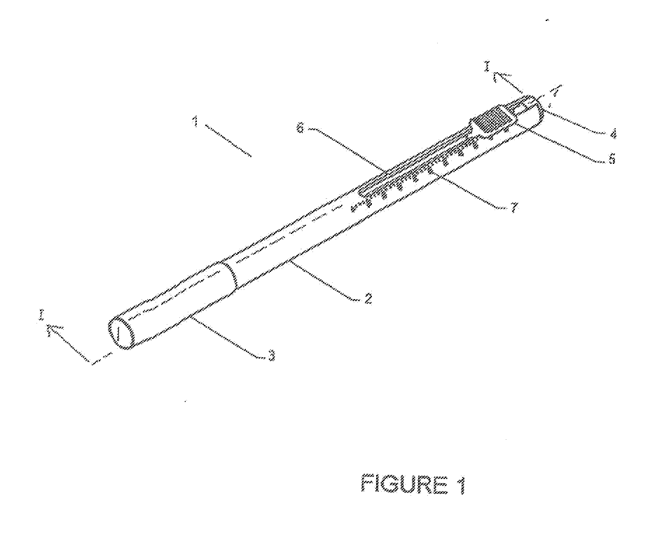

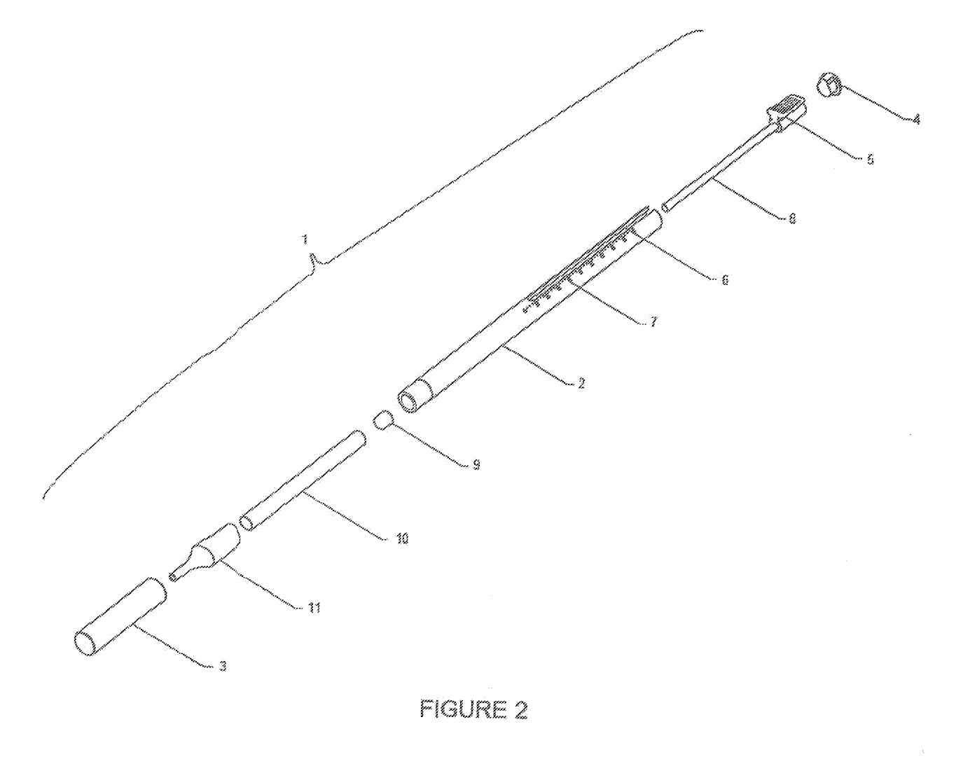

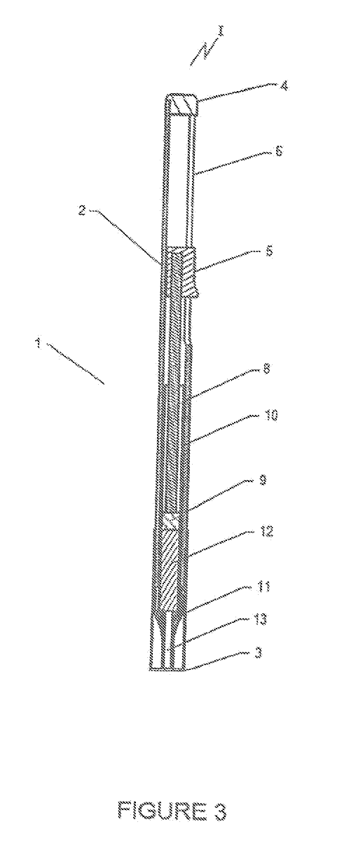

According to one embodiment of the present invention, presented in FIG. 1 is a schematic drawing of a complete metered dispensing device 1 incorporating a manually moveable slide driven advancing member. The assembly comprises first a cartridge housing 2 with an installed proximal cap; integrated with the cartridge housing is the advancing member comprised of a housing 2, a finger grip 5 associated with a piston (not depicted), an advancement slot 6 for permitting travel of the finger grip, a distal housing cap 4 for retaining the sliding piston, and a visible graduated scale 7 for indicating the relative position of the plunger rod. As further detail, an exploded view of metered dispensing device 1 is presented in FIG. 2 and a transverse sectional view 1 is presented in FIG. 3. FIG. 2 and FIG. 3 provide further detail of the internal components, wherein the assembly consists of first a proximal cap tor providing cover for the extruding conduit tip 11; a extrusion conduit tip 11 having a fluid-flow conduit 13, which may alternatively be comprised of multiple sections or elements in various embodiments previously disclosed; an exchangeable cartridge 10 containing a functional substance 12 (depicted in FIG. 3 only); a cartridge plug 9, which may be standalone or fixed to plunger rod a cartridge housing 2 also providing house for the advancing member having a sliding slot 8 and a visible graduated scale 7 (depicted in FIG. 2 only); a plunger rod 8 fixed to finger grip 5; a finger grip 5 having a shape that slidingly engages with the internal bore of housing 2 to maintain axial alignment of the plunger rod and finger grip; and finally a distal housing cover for keeping the sliding components in place and easing manufacture.

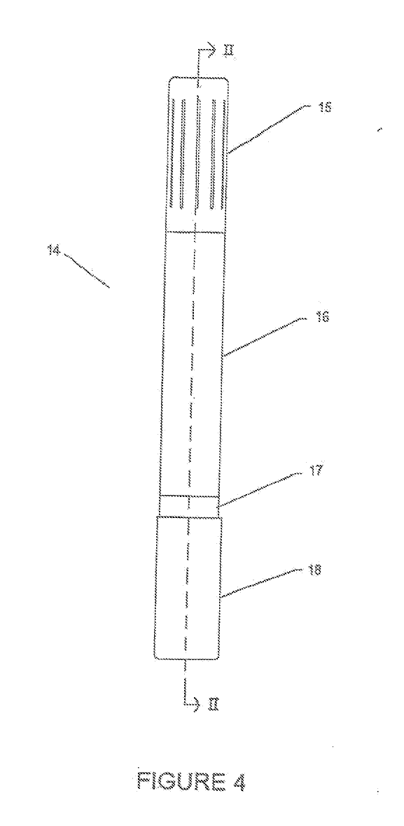

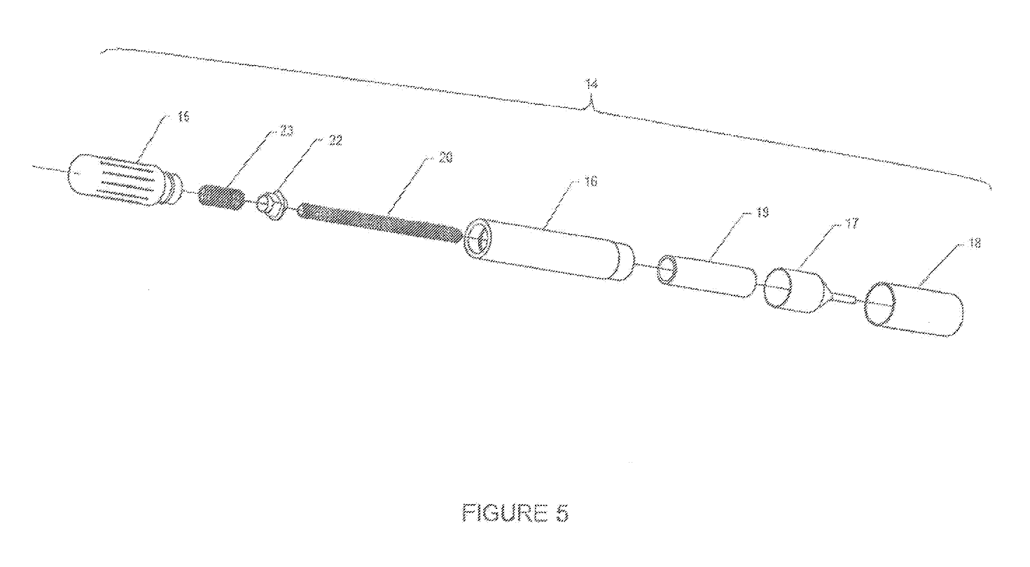

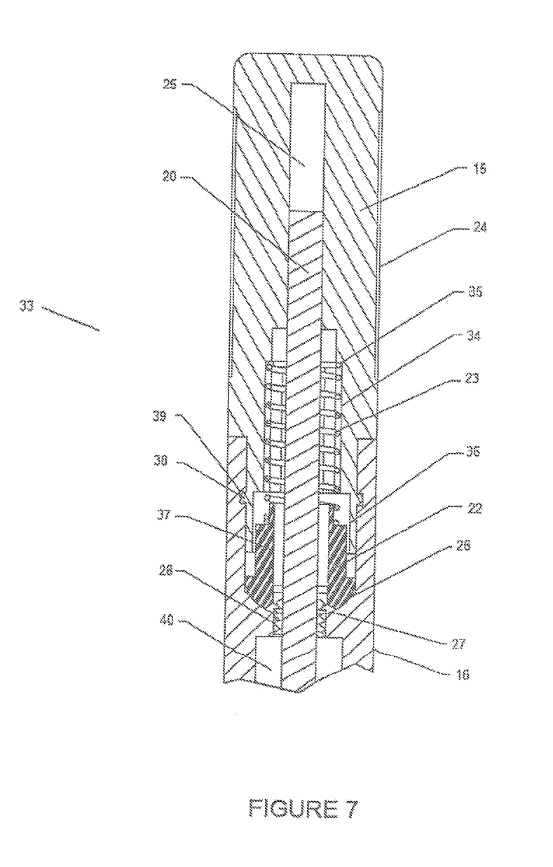

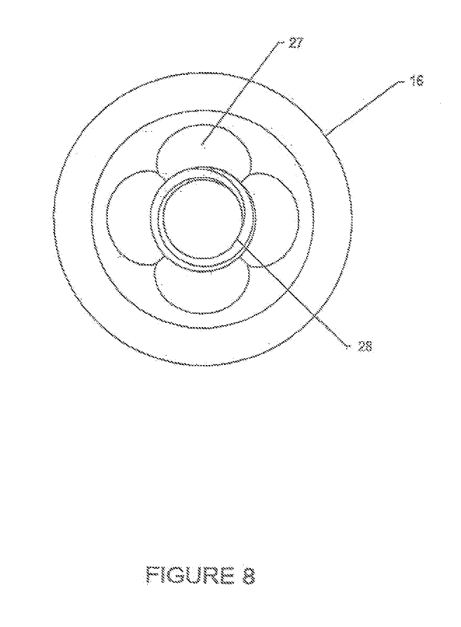

According to an additional embodiment of the present invention, presented in FIG. 4 is a schematic drawing of a complete metered dispensing device 14 incorporating a manually rotatable element for driving a screw plunger. In accordance with FIG. 1, the assembly 14 comprises a manually rotatable element 15, a cartridge housing 16, an extrusion conduit tip 17, and a proximal cap 18. As further detail, an exploded view presented in FIG. 5 presents the internal and external components of the assembly. The assembly is comprised of first a manually rotatable element 15, which may include grip features and textures; a coil spring 23 for providing pressure against multi-lobed pin 22, an advanceable screw 20, a cartridge housing and advancing member 18, an exchangeable cartridge 19 containing a functional substance (not depicted), an extrusion conduit tip 17, which may alternatively be comprised or multiple sections or elements in various embodiments previously disclosed; and finally a proximal cap 18 for providing cover for the extrusion conduit tip 17. In further elaboration, a transverse cross sectional view II of device assembly 14 is illustrated in FIG. 8. Presented is the assembly and various parts and features comprised of first a manually rotatable element 15, having on its exterior a textured surface 24 for improving user interaction; an advanceable screw 20, wherein the open interior region 25 of element 15 depicts the orientation where clearance in provided for the screw threaded region to pass through its center; a helical spring 23 in contact with a retaining feature of element 15 and a distal face of the multi-lobed pin 22 for providing pressure of protruding lobes 28 into the recessed lobes 27 of the cartridge/mechanism housing 16; a threaded hole 28 of the annular feature of housing 18 for engaging with the threaded section of plunger shaft 20; an exchangeable cartridge casing 10 retained in housing 16 by a retaining feature 29 of housing 16; a cartridge ping 30, a functional substance 12, an extrusion conduit tip 17 having a fluid-flow conduit 32; and finally a proximal cap 18. Providing further detail, depicted in FIG. 7 is a partial detail view 33 of sectional view II at a 90 degree axial rotation of cross sectional view II. FIG. 7 illustrates further detail of device assembly 14 and in particular shows the association of the two flattened sides of the advancing screws with the internal features of manually rotatable element 15, illustrating how the internal features are able to act upon the screw and rotate it.

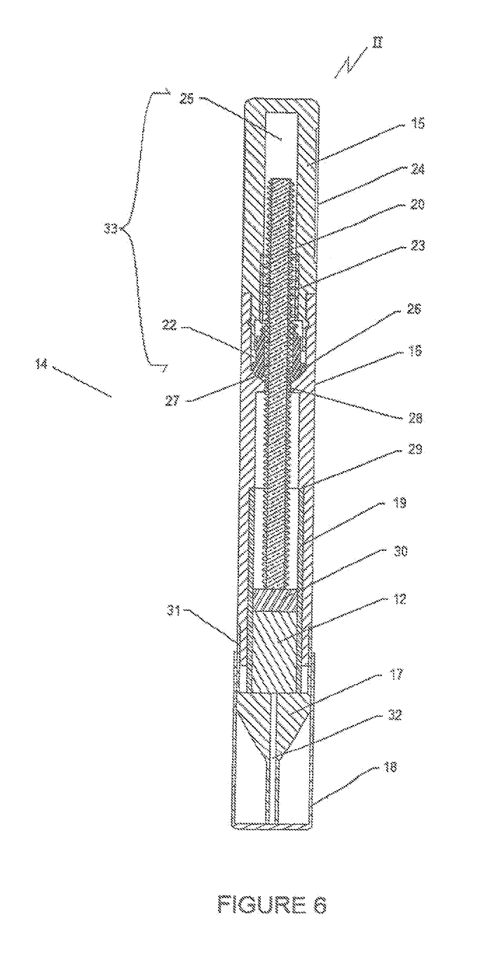

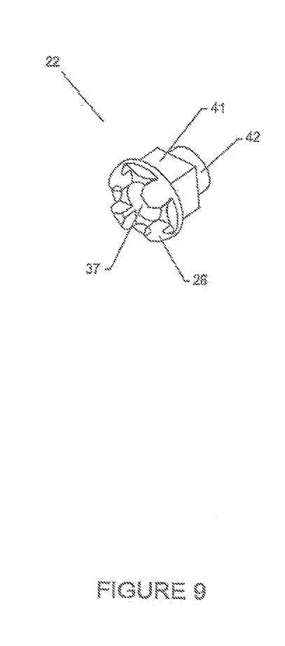

FIG. 7 illustrates further detail of the advancing member wherein the assembly comprises a manually rotatable element 15; a grip texture 24, an interior cavity 25 for permitting the advancement of the screw plunger 20, a spring retaining feature 35 of element 15; a spring slot 34 of element 15; an annular extrusion 38 of element 15 fixed into a slot 39 in the inner diameter of the bore of the mechanism housing 16, which serves to retain the element 15 from dislodging from housing 16, but also permit its axial rotation; a sliding slot 38 of element 15 for mating with and permitting a space for multi-lobed pin 22 to slide vertically during its rotation with element 15; a bore 37 in multi-lobed pin 22 for free passage of the advancing plunger 20; a depressed lobe section 27 of an annular feature of housing 18 for interaction with protruding lobes 26 of multi-lobed pin 22; a threaded hole in the center of the annular feature of housing 16; and finally an open chamber of housing 18 for free rotation of advancing plunger 20. As further elaboration on the depressed lobe features of the annular section of housing 16, FIG. 8 is a top view of housing 16 illustrating four depressed lobes 27 and threaded hole 28. Furthermore, FIG. 9 is an orthogonal side view of multi-lobed pin 22, showing further detail of the pin wherein the pin includes four protruding lobe sections 20; a center through-hole 37, a square shaped section 41 for mating with element 15 depicted in FIGS. 4-7 to transfer rotational motion to the pin; and a short annular section for alignment with the axially oriented helical spring 23 depicted in FIGS. 5-7.

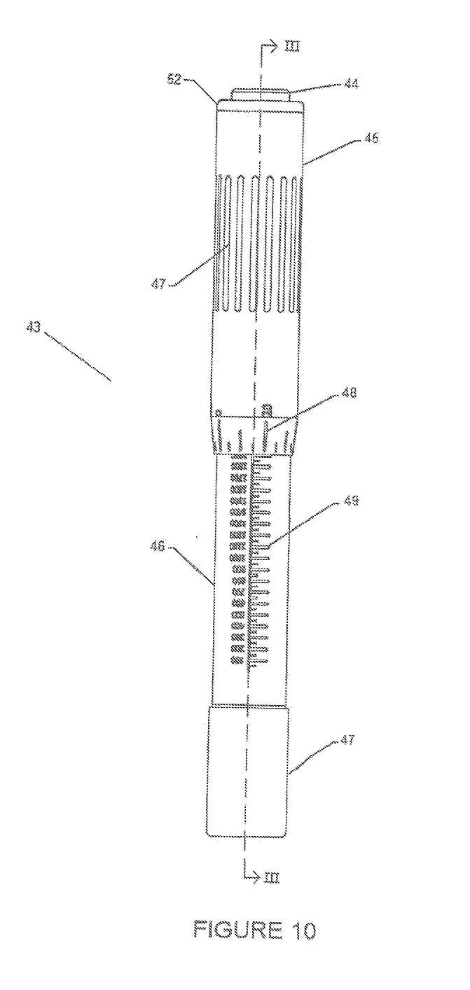

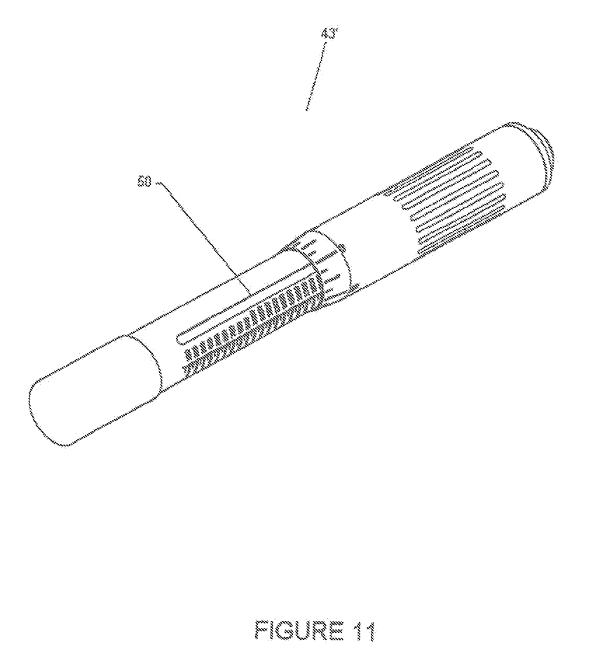

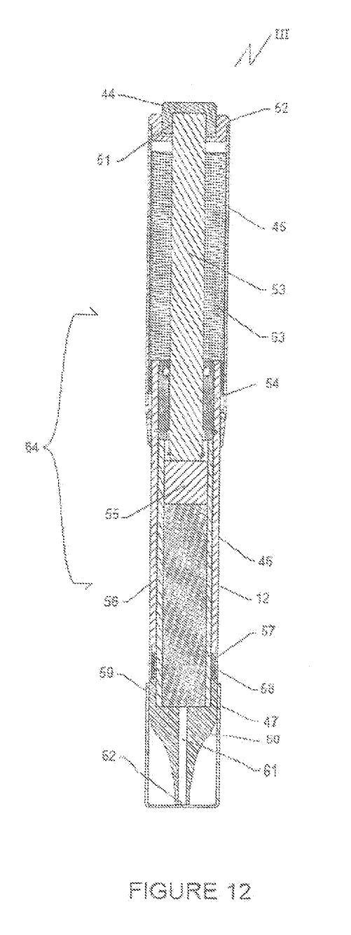

As an additional embodiment of the present invention utilizing an advanceable stop block advanceable mechanism, FIG. 10 is a schematic view of device 43, comprised of a cartridge housing 48; an advanceable stop housing 45 having a textured grip surface 47 to improve a user's ability to rotate the body; a distal and cover for providing stop block surface for depressible piston rod distal end 44; a radially printed graduated scale 48 on the stop block housing 48 that coordinates with the graduated scale printed on the cartridge housing 46; and finally a proximal end cap 47 for providing cover for an extrusion conduit tip. Furthermore, in a similar but alternative embodiment, FIG. 11 depicts an embodiment 43′ having a slot 50 extending an axial length of the cartridge housing. Turning to FIG. 12, further detail is depicted in a transverse cross sectional view III of device 43 derived from FIG. 10 noting major interior features and elements. Continuing further details of device 43 in FIG. 12, the assembly comprises first a cartridge housing 46, partially containing an exchangeable cartridge casing 58 containing a functional substance 12 and a plug 55; Connected to housing 46 at its proximal end is an extrusion conduit tip 80 with a fluid-flow conduit channel 61 and open end 82 abutted to the interior surface of proximal cap 47 while also partially containing the proximal end of exchangeable cartridge casing 56 and functional substance 12 and being threaded with threads of its own 57 into the threaded end 58 of housing 46; an advanceable stop housing 45 threaded on its interior to housing 46 with threads 83; a distal stop block 52 installed in advanceable stop housing 45; and finally a depressible piston rod 43 with a distal end 44 aligned info channels provided by stop block 52 and piston retainer 54.

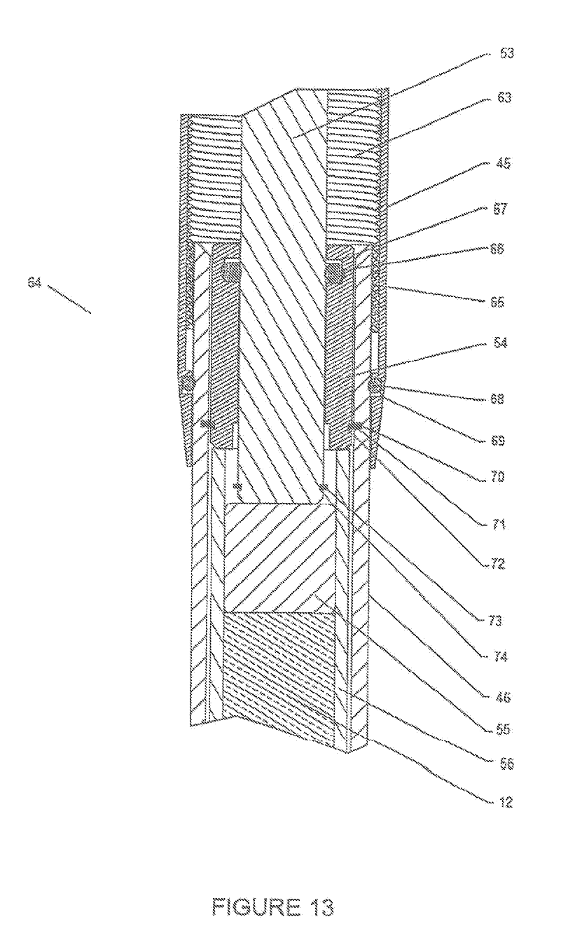

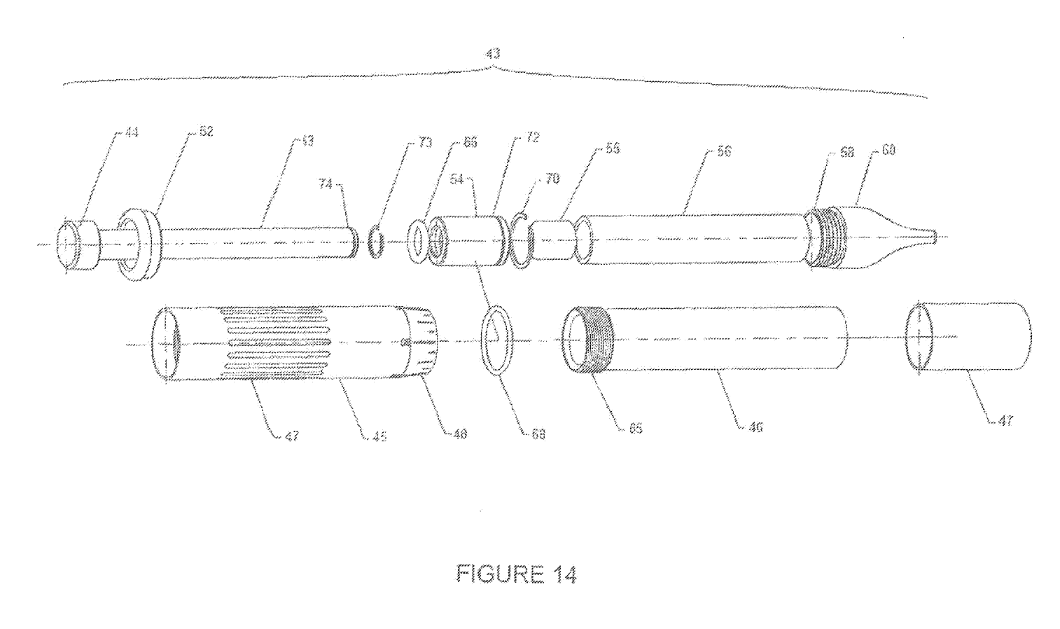

Turning to FIG. 13, a detail section 64 of FIG. 12 is illustrated to finer details of device 43. FIG. 13 illustrates further detail of 43 including first a cartridge housing 46 containing an exchangeable cartridge with casing 56 abutted against the proximal face of piston retainer 54, and also containing functional substance 12, and plug 55; an advanceable stop housing 45 having threads 63 meshed with threads 65 of housing 48 and having an annular slot 69 cut into a slot proximal of the threads 85 containing an o-ring for providing a moderate resistance to the helical rotation of the advanceable stop housing 45 as the o-ring transverses the exterior surface of housing 40; a piston retainer 54 having interior slot 67 retaining an o-ring 86 for providing a moderate resistance to the sliding motion of depressible piston rod 53; a piston retainer 54 having an exterior slot 72 retaining a snap ring 71, the snap ring of which is also retained in a slot 70 of housing 46 providing the function of locking piston retainer 54 in place in the housing 46; and finally a slot 74 cut into the proximal end of depressible piston rod 53 retaining a snap ring 73 for preventing the rod from sliding out of the distal end of the piston retainer 54. As further detail, an exploded view of device 43 is provided in FIG. 14 illustrating the details of device 43 discussed herein in an exploded view.

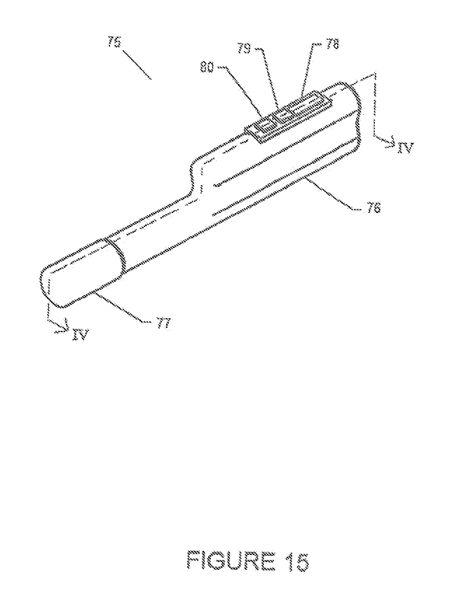

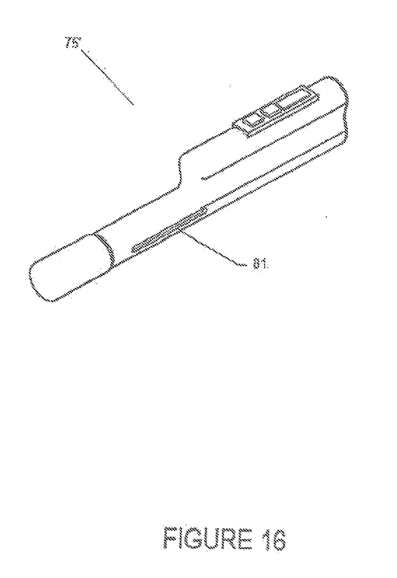

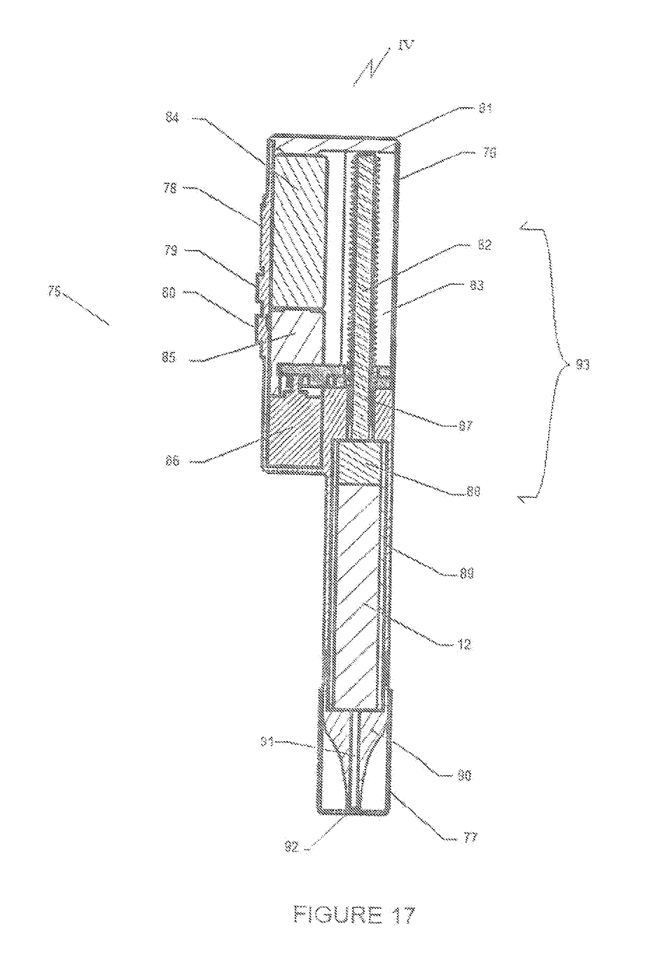

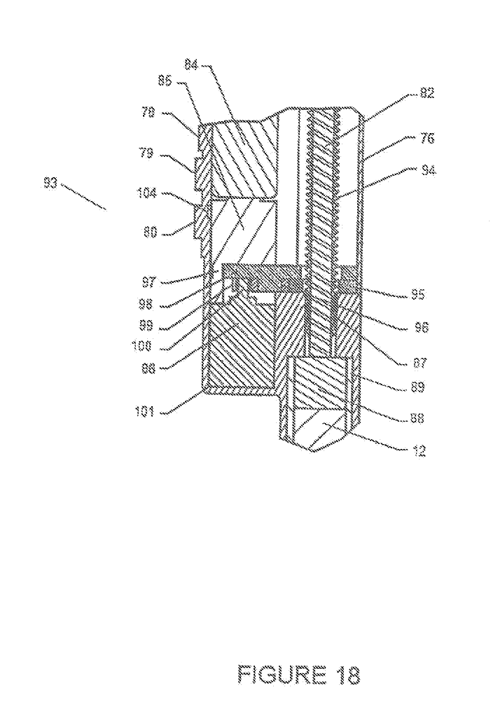

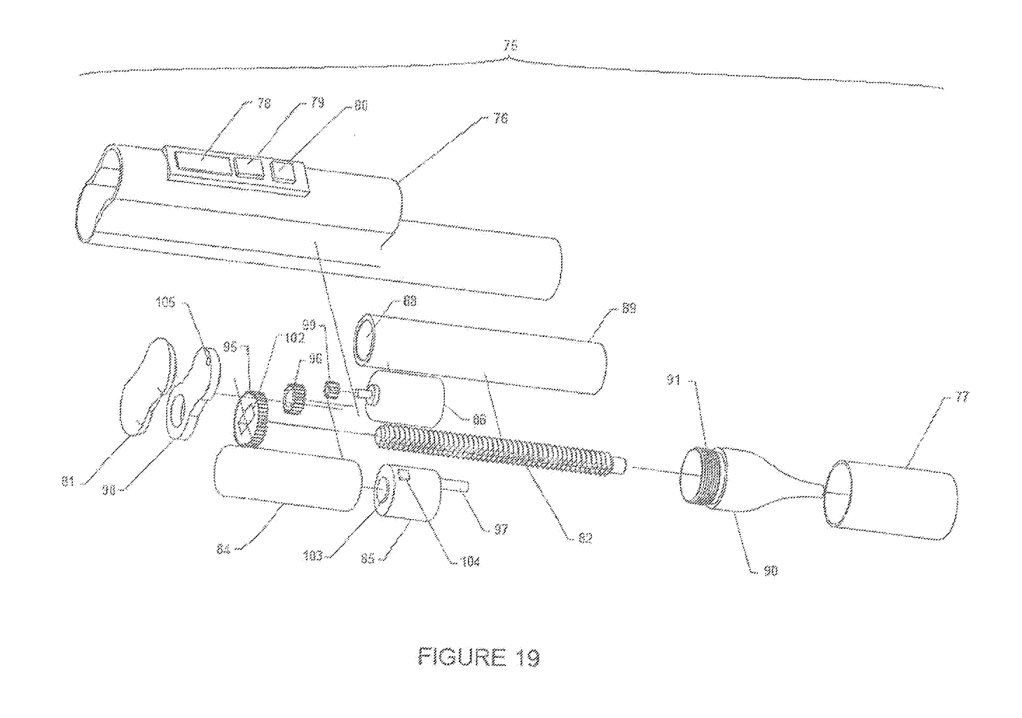

In yet an additional embodiment of the present invention comprising an electronically operated advancing member, FIG. 15 is an proximal side view illustrating a device 75 comprised of a housing 78, a proximal cap 77, a button 80, a button 79, and an electronic display 78. As an alternative but similar embodiment, FIG. 16 is a proximal side view of device 75 having a cartridge viewing slot 81. FIG. 17 is a transverse cross sectional view IV of device 75 depleting further detail of device 75, which comprises first a device housing 76, which houses both a cartridge and an advancing member; a proximal cap 77 and a distal cap 81, both removably retained; a extrusion conduit tip 90 having a fluid-flow conduit 91 and open end 92 abutting the interior face of proximal cap 77; an exchangeable cartridge casing 89 containing a functional substance 12 and plug 88; an advanceable screw plunger 82 inside a screw housing section 83 of device housing 76; and a user interface assembly comprising a button 80, a button 79, and an electronic display 78 in electrical communication with an electronic control circuit 85, which is also in electrical communication with electric motor 88 via an extension 104 (depicted in FIGS. 18 and 19) and battery 84 via an extension 103 (depicted in FIG. 19). In various embodiments, electrical current flow may be achieved by an electrical element establishing contact with one lead of the battery by a connection, such as 103, and otherwise establish a circuit by establishing contact with the device housing, which would also be in electrical communication with the other lead of the battery. Also, in this and other embodiments, the battery may be exchangeable by removing a cover, such as cover 81, or may be rechargeable and be charged through electrical leads externally accessible on the housing or an element associated with it.

Furthermore a sectional detail view 93 depicted in FIG. 18 and an exploded view of device 75 depicted in FIG. 13 illustrates greater detail of the advancing member, which comprises those elements noted in FIG. 17 in addition to an electrical communication port 104 extending from the electrical control circuit 85 that serves to connect the electrical control circuit 85 to the user interface features 80, 79, and 78; an electrical communication port 97 extending from electrical control circuit 85 through a passage port 105 (depleted in FIG. 19) in gear retainer unit 88 to electrical motor 86 retained in housing slot 101 and having rotational force transfer shaft 100 connected to drive gear 99; a gear retainer unit 98 retaining idler gear 98, which is meshed with drive gear 99 and meshed with actuator gear 95; a actuator gear 95 having a rectangular void section 102 at its axial center (depicted in FIG. 19) for providing a contact surface with the advancement screw 82 having a two flat transverse surfaces and tow partially threaded radial faces for meshing with a threaded hole 87 of housing 78.

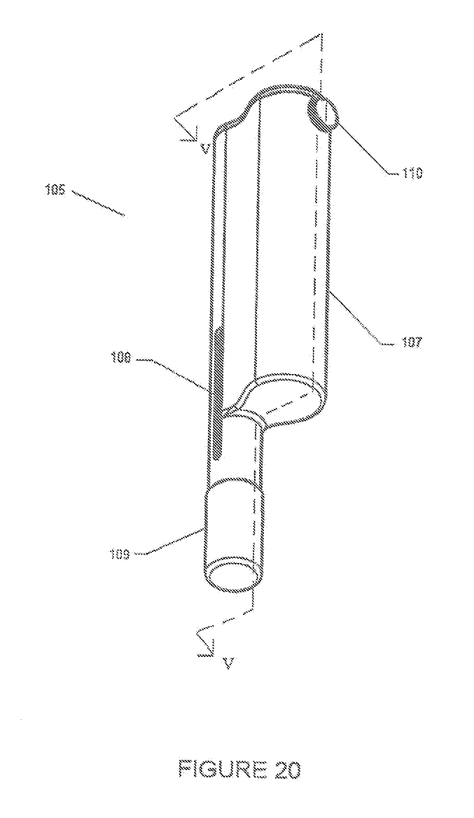

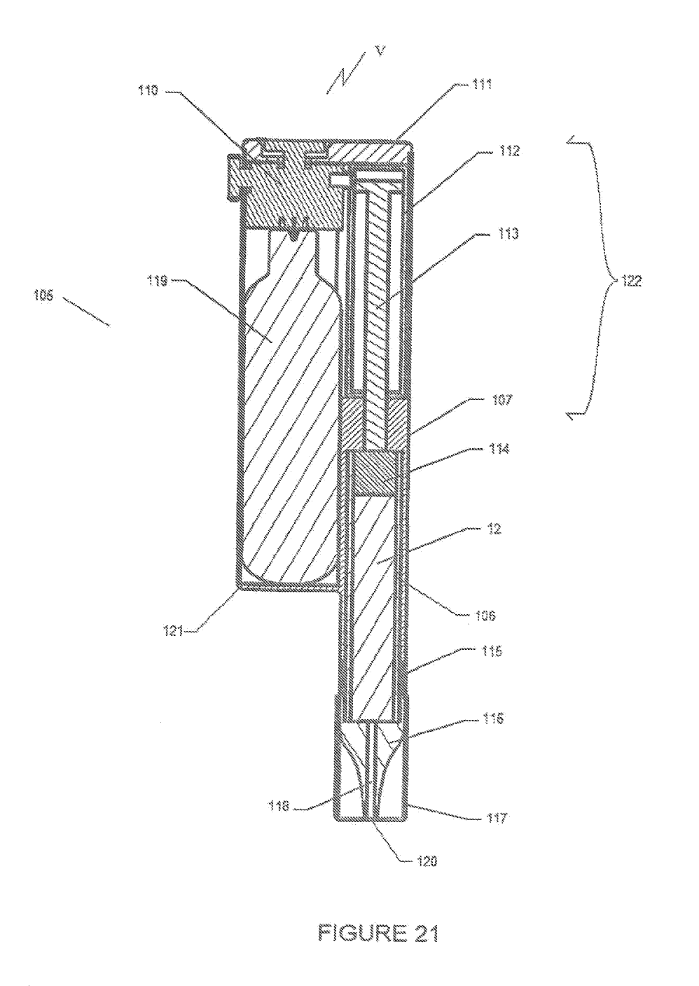

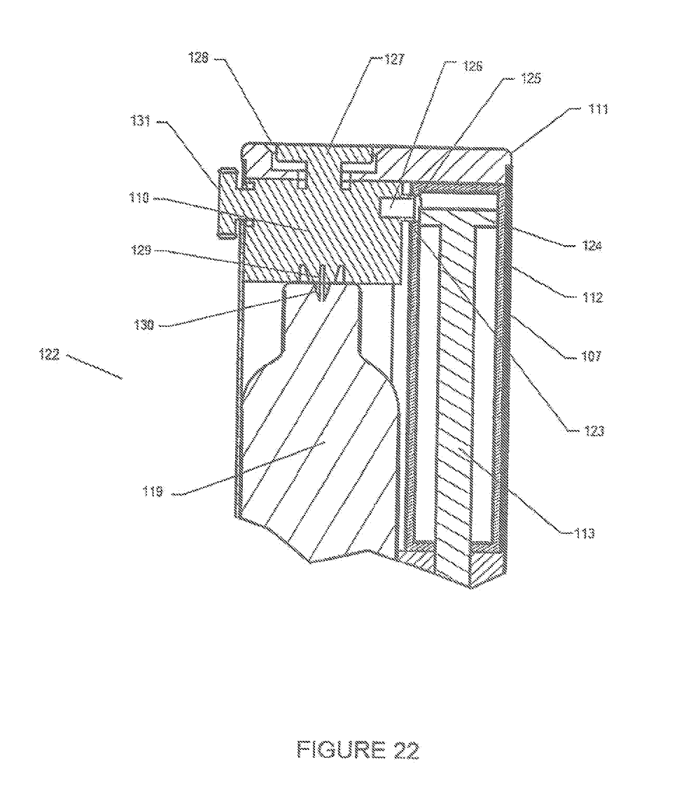

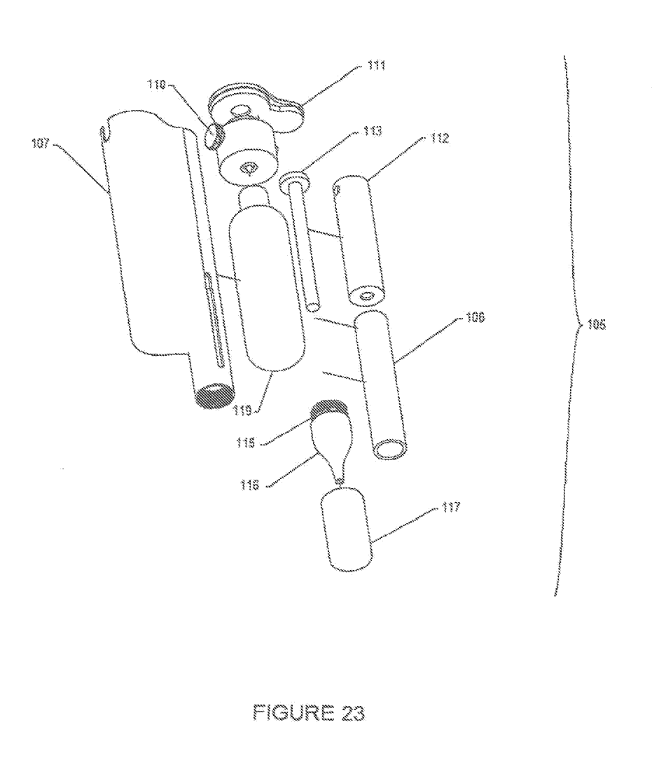

In yet another embodiment of the present invention, a pneumatic advancing member may be employed in the present invention and is illustrated in FIG. 20 comprising a device 105 with a device housing 107, a manual valve adjustment knob 110, a cartridge viewing slot 108, and a proximal cap 109. Furthermore, FIG. 21 depicts a transverse cross sectional view V of device 105 illustrating major interior components, including a device housing 107, containing on exchangeable cartridge comprised of casing 106, functional substance 12, and plug 114; an extrusion conduit tip 118 with threaded section 116 for mating with device housing 107, having a fluid-flow channel 118 with a proximal open end abutted to an interior surface of removably retained proximal cap 117; a plunger rod 113; a pneumatic cylinder 112; a valve body 110; a compressed gas cylinder its removably retained in a housing slot 121. Furthermore, in a sectional detail view 122 depicted in FIG. 22, further detail of the advancing member is illustrated including features previously disclosed in FIGS. 20 and 21 in addition to more specific features, including a pneumatic cylinder piston 124 associated with plunger rod 113; a needle conduit 130 for establishing fluid communication of pressurized gas of pressure tank 119 with the valve assembly 110; a manually adjustable knob associated with the valve assembly to permit a user to adjust the flow and pressure settings of the gas flow into the pneumatic cylinder; a depression 128 in the distal housing cover 111 to provide space for a depressible button 127; and a gas flow conduit 128 of extended stem 123 of valve assembly 110 that directs gas flow from the pressure tank 119 to the pneumatic cylinder through a port 128 in the pneumatic cylinder 122 side wall. Furthermore, an exploded view of device 105 is depicted in FIG. 23 illustrating various features disclosed in FIGS. 20-22. In all embodiments, preferably the compressed gas tank would preferably be exchangeable through a door in the housing, whether it be on the side, on a proximal end, or from a distal end of the device housing.

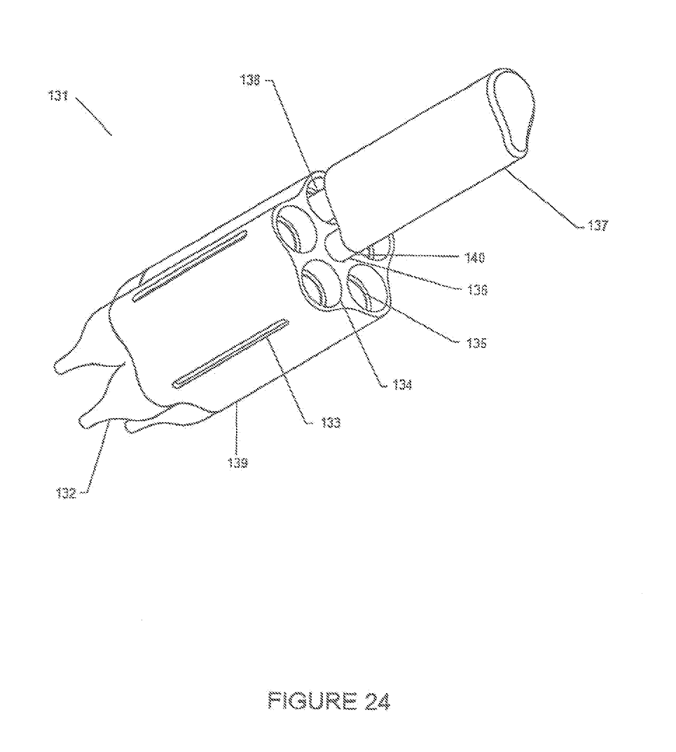

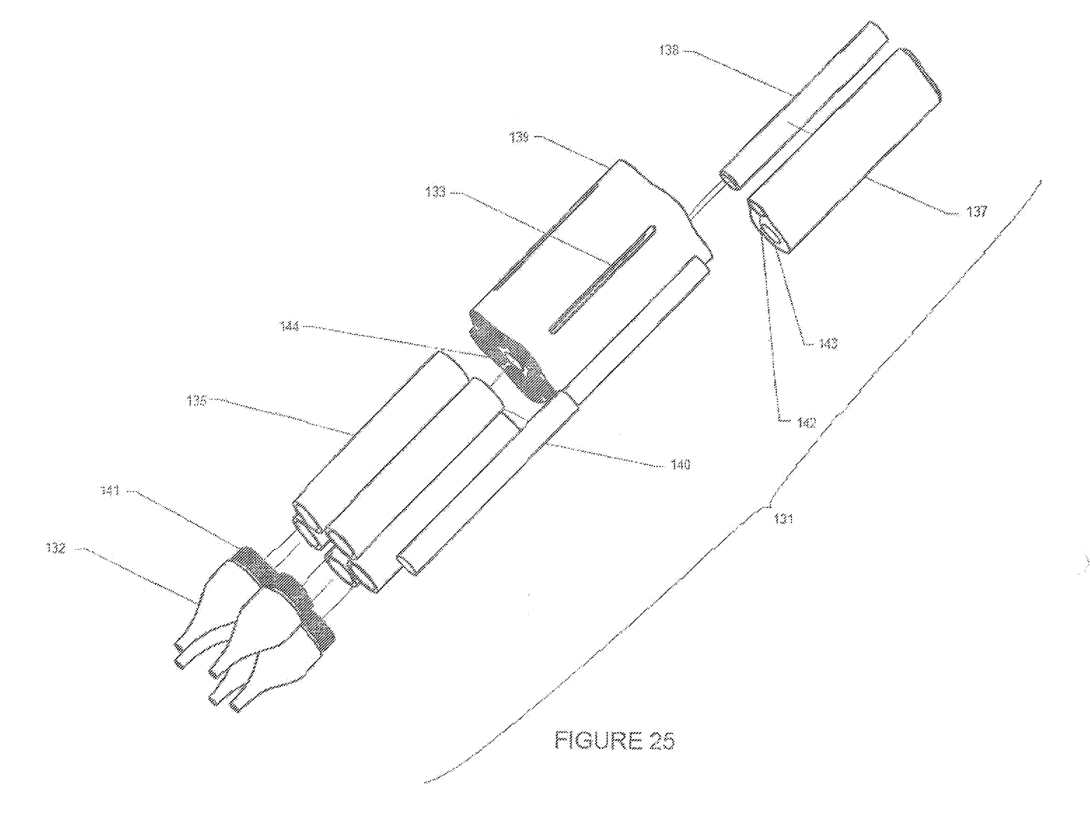

In yet an additional embodiment of the present invention, a device assembly may comprise a cartridge housing capable of housing multiple cartridges. FIG. 24 depicts a distal schematic view of an assembly 131 comprised of a multi-cartridge housing 133, having also cartridge viewing slots 133, an array of extrusion conduit tips 132, an array of cartridge housing slots 134, an array or cartridges 135, a channel for receiving an advancing member rotational axle 140, an advancing member 137, and an advanceable plunger rod 138. Furthermore an exploded view of assembly 131 is provided in FIG. 25 comprised of details disclosed in FIG. 24 in addition to a threaded section 141 of extrusion conduits 132 for connection with cartridge housing 139; an advanceable plunger rod 138 associated with a section 143 of the advanceable mechanism 137; a section 142 associated with the rotational axis 140 for controlled placement of the advanceable mechanism, which is also associated with a passage 144 of multi-cartridge housing 144.

In all embodiments of the present invention disclosed herein, the extrusion conduit tip may be comprised of simply a fluid flow channel, or may be a cartridge retaining element comprised of additional features or even be comprised of multiple sections having various functional features as previously disclosed.

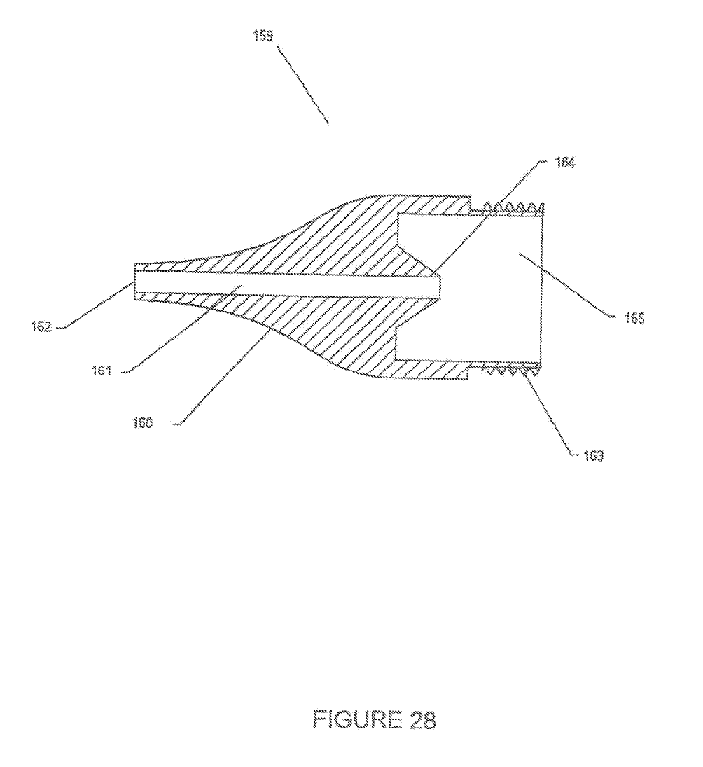

Turning to FIG. 28, depicted is transverse sectional view of a SSPCRE 145 having a SSPCRE body 146, a cartridge receiving section 148, a threaded section 147, a fluid flow conduit 151 with a proximal open end 150, and a heater element feature 149 placed in line with the fluid flow. In such an embodiment the flow of functional substance would pass through or around the element in order to gain heat energy. Additionally, the heating element would be in electrical communication with an electrical source (not shown) or would be an element capable of retaining a significant portion of heat over a usable period of time. Such an element could be heated by placement in a microwave or heated by direct exposure to a heat source.

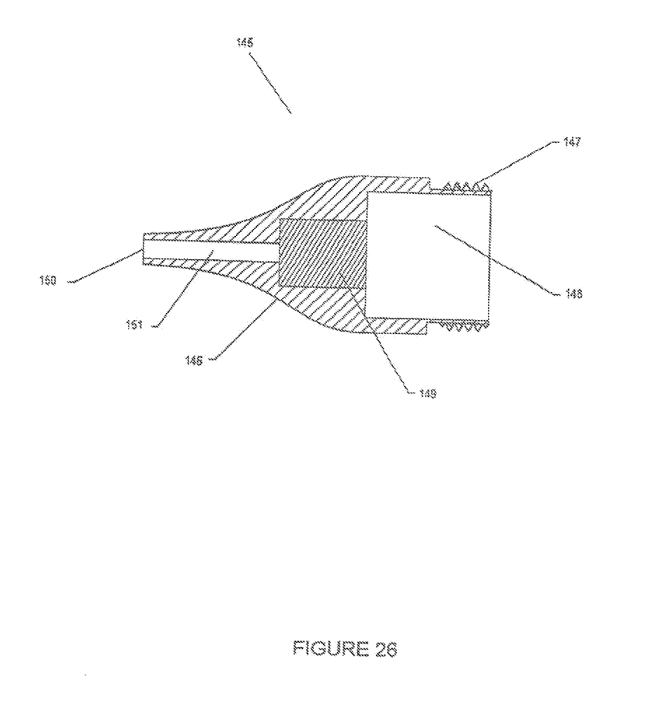

In an alternative embodiment of the SSPCRE 148 of FIG. 26, the element 149 may be a unidirectional valve body.

In an alternative embodiment of the SSPCRE 145 of FIG. 26, the element 149 may be a pierceable septum from either a proximal or distal end.

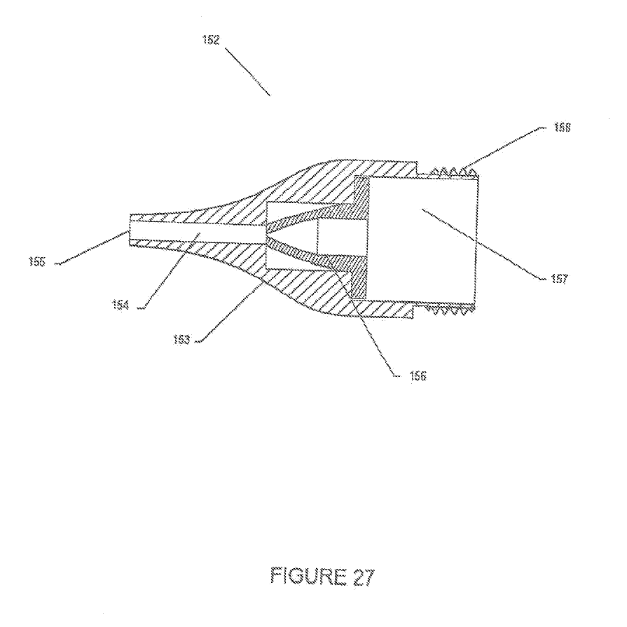

Turning to FIG. 27, depicted is a transverse sectional view of an additional embodiment 152 of an SSPCRE composed of a body 153, a cartridge receiving section 157, a threaded section 158, a fluid-flow conduit 154 with a proximal open end 155, and a unidirectional duck-bill style valve 156 placed in-line with the fluid flow. In such an embodiment, flow of functional substance would only be permitted to flew from a distal end to a proximal end, but not the inverse.

Turning to FIG. 28, depicted is a transverse sectional view of an additional embodiment 159 of an SSPCRE comprised of a body 160, a cartridge receiving section 165, a threaded section 163, a fluid-flow conduit 161 with a proximal open end 162, and a distal facing tapered needle conduit 164 placed in-line with the fluid flow. In such an embodiment, flow of functional substance would only be established ones the needle section punctures a film or septum of a cartridge.

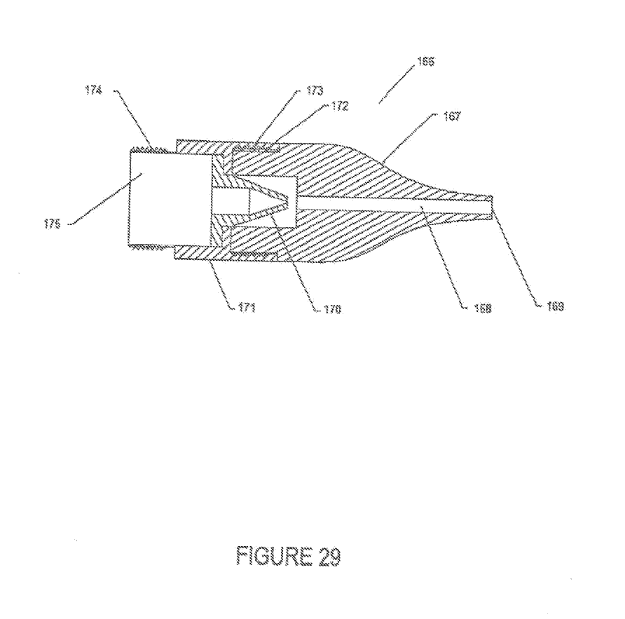

Turning to FIG. 29, depicted is a transverse sectional view of an additional embodiment 166 of a MSPCRE comprised of two bodies 167 and 171, a cartridge receiving section 175, a threaded section 174 of body 171 for mating with a cartridge housing, a threaded section 173 of body 171 for meshing with a threaded section 172 of body 167, a fluid-flow conduit 168 with a proximal open end 169, and a unidirectional duck-bill style valve 156 associated with body 171 and placed in-line with the fluid flow. In such an embodiment, flow of functional substance would only be permitted to flow from a distal end to a proximal end, but not the inverse. Additionally body 167 would be able to be removably retained in body 171 and would permit a user to easily exchange body 167 without exposing the cartridge to atmospheric gases.

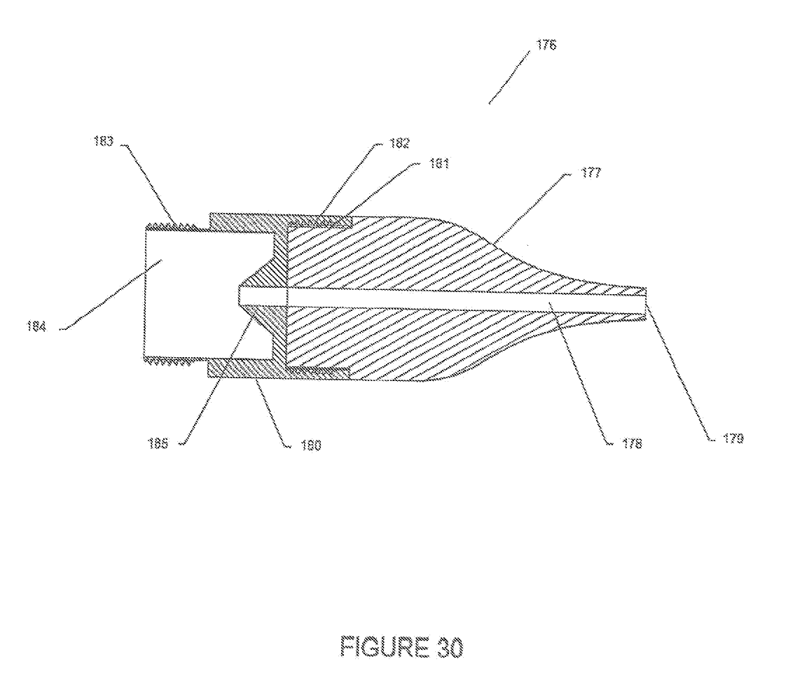

Turning to FIG. 30, depicted is a transverse sectional view of an additional embodiment 176 of a MSPCRE comprised of two bodies 177 and 180, a cartridge receiving section 184, a threaded section 183 of body 180 for mating with a cartridge housing, a threaded section 182 of body 180 for meshing with a threaded section 181 of body 177, a fluid-flow conduit 178 with a proximal open end 179, and a distal facing tapered needle conduit 185 placed in-line with the fluid flow. In such an embodiment, flow of functional substance would only be established once the needle section punctures a film or septum of a cartridge. Additionally body 177 would be able to be removably retained in body 180 and would permit a user to easily exchange body 187 without exposing the cartridge to significant portions of atmospheric gases.

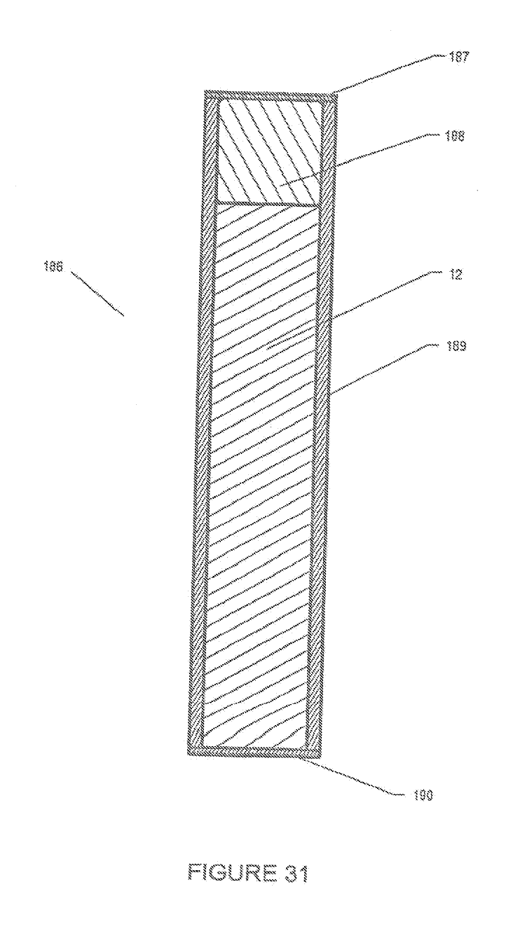

Turning to FIG. 31, depicted is a transverse sectional view of an embodiment 186 of an exchangeable cartridge comprised of a cartridge easing 189, a functional substance 12, a plunging plug 188, an adhered distal sealant film 187, and an adhered proximal sealant film 190. Furthermore the films 190 and 187 may be heat sealed films, adhesive adhered films, adhered elastomeric septa, or other analogous films that are fixed to the distant ends of the cartridge casing 189 and would preferably be removable by a user.

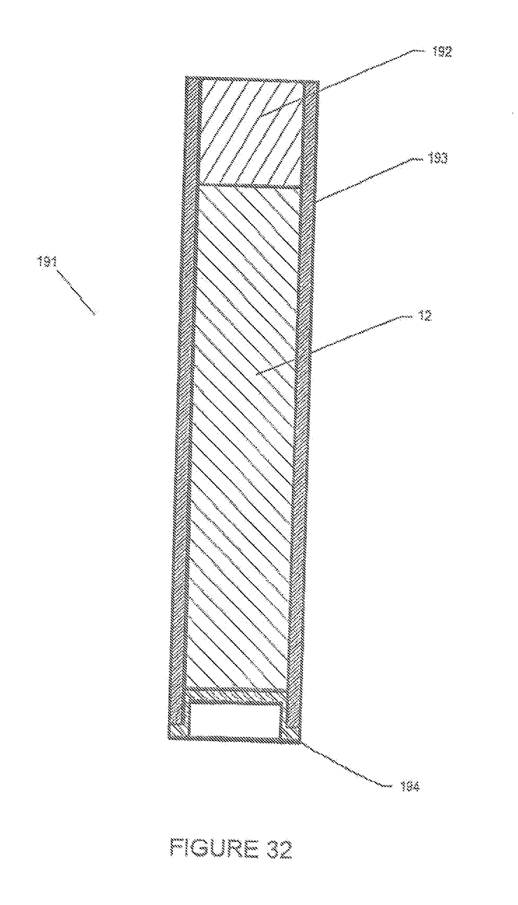

Turning to FIG. 32, depleted is a transverse sectional view of an embodiment 191 of an exchangeable cartridge comprised of a cartridge casing 193 with an open distal end, a functional substance 12, a plunging plug 192, and a compression Inserted proximal end-plug 194. In such an embodiment the end-plug 194 may be removable prior to use of the cartridge or may be pierced by a septum to establish fluid communication with functional substance 12. In such an embodiment, preferably the plunger plug 192 would establish a seal with the easing inner diameter bore sufficient to prevent atmospheric gas influx.

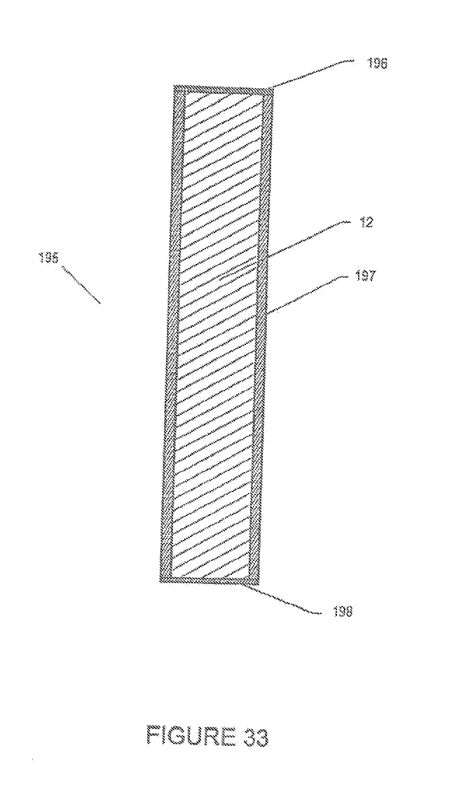

Turning to FIG. 33, depicted is a transverse sectional view of an embodiment 195 of an exchangeable cartridge comprised of a cartridge casing 197, a functional substance 12, an adhered distal sealant film 196, and an adhered proximal sealant film 198. Furthermore the films 196 and 198 may be heat sealed films, adhesive adhered films, adhered elastomeric septa, or other analogous films that are fixed to the distant ends of the cartridge casing 197 and would preferably be removable by a user. In such an embodiment the cartridge lacks a plunger plug, which would otherwise be installed on a plunger rod associated with an advancing member.

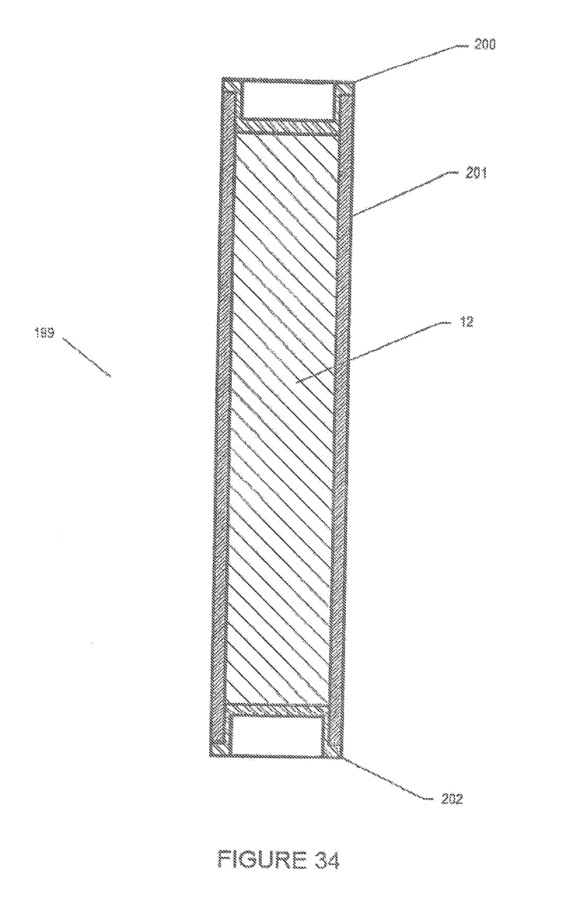

Turning to FIG. 34, depicted is a transverse sectional view of an embodiment 199 of an exchangeable cartridge comprised of a cartridge casing 1201, a functional substance 12, compression inserted distal end-plug 200, and a compression inserted proximal end-plug 202. In such an embodiment the end-plugs 200 and 202 may be removable prior to use of the cartridge or may be pierced by a septum to establish fluid communication with functional substance 12.

Turning to FIG. 34, depicted is a transverse sectional view of an embodiment 199 of an exchangeable cartridge comprised of a cartridge casing 201, a functional substance 12, compression inserted distal end-plug 200, and a compression inserted proximal end-plug 202. In such an embodiment the end-plugs 200 and 202 may be removable prior to use of the cartridge or may be pierced by a septum to establish fluid communication with functional substance 12.

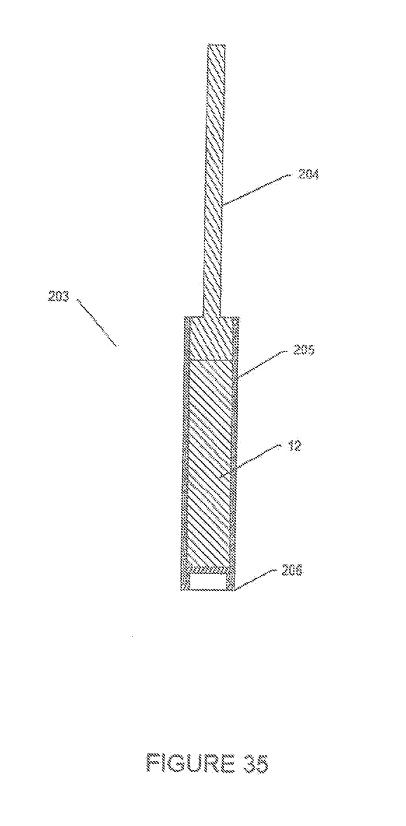

Turning to FIG. 35, depicted is a transverse sectional view of an embodiment 203 of an exchangeable cartridge comprised of a cartridge casing 205, a functional substance 12, compression inserted proximal end-plug 206, and a plunger plug having an advancing rod associated with it that may be inserted into an advancing member. In such an embodiment the end-plug 206 may be removable prior to use of the cartridge or may be pierced by a septum to establish fluid communication with functional substance 12. In an alternative embodiment (not depicted) a similar arrangement could be envisaged where an adhered film would take place of end-plug 206.

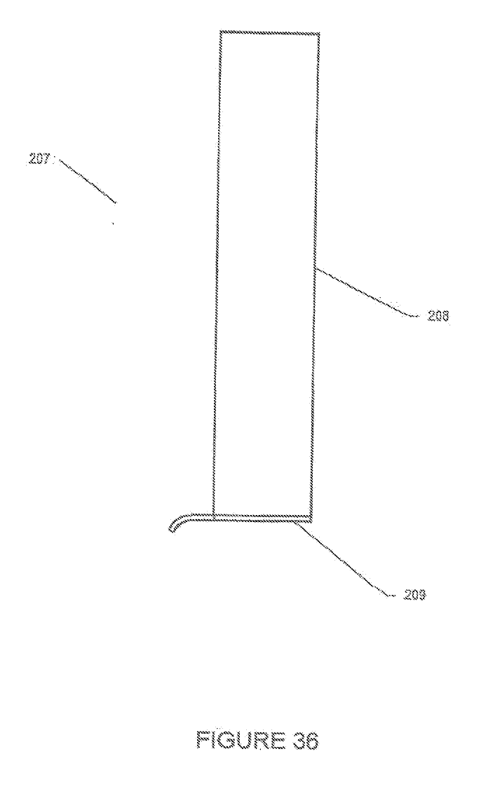

Turning to FIG. 36, depicted is a schematic side view of an embodiment 207 of an exchangeable cartridge comprised of a cartridge 208 having a film 208 with a pull tab adhered to the proximal end of the cartridge casing. In such an embodiment, the pull tab would make it easier for a user to manually remove the film. In all previous embodiments disclosed, wherein a film seal is incorporated, those films may also alternatively include a pull tab as disclosed herein.

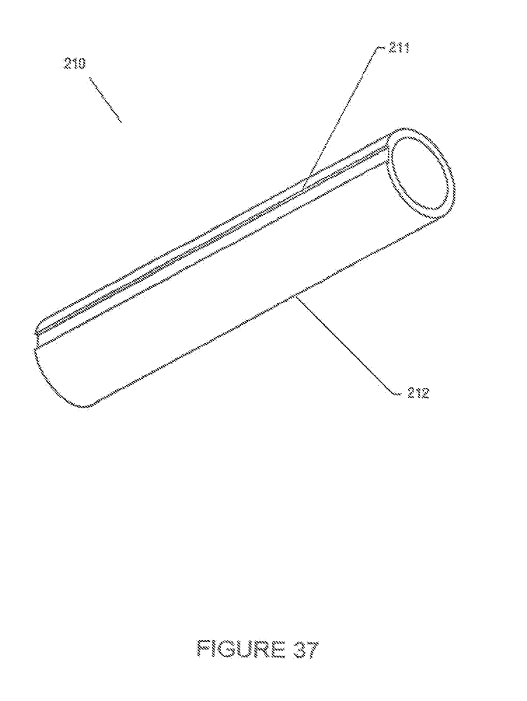

Turning to FIG. 37, depicted is a schematic side view of an embodiment 210 of an exchangeable cartridge comprised of a cartridge casing 212 having a slot passing down its transverse length, which in various embodiments may be incorporated into cartridges to provide them with a key slot for fitting into specific cartridge housing having a matching key. Alternatively, the key slot here depicted may alternatively be a protruding key that would serve the same function, but simply be protruding rather than recessed.

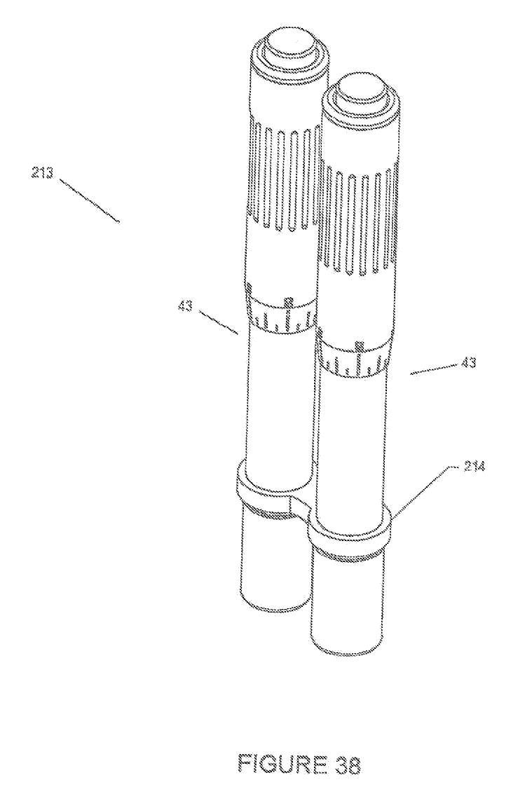

Turning to FIG. 38 a multi-device assembly 213 is presented wherein a connection element 214 connects two devices of the present invention 43 to an identical device 43. Alternatively, two non-identical devices of the present invention may be connected together in a similar fashion.

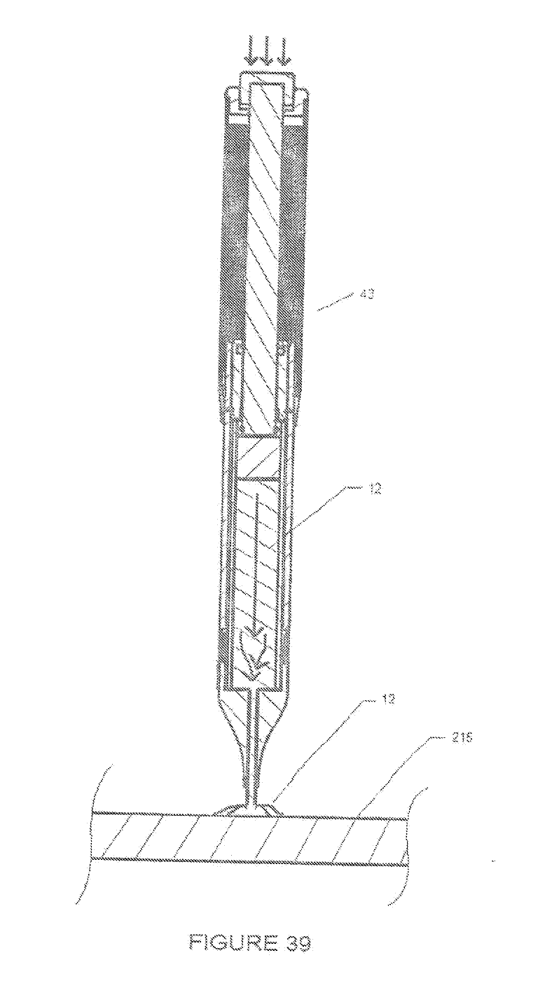

Turning to FIG. 39, a figure is presented in order to illustrate an exemplary process of action that the present invention would undergo during use; a device 43 is presented wherein arrows representing physical force at its distal end is transferred down to a cartridge and consequently the force is exerted on the functional substance 12, forcing it to be extruded through the extruding conduit tip and deposited exterior to the device (noted as 12′) on a physical surface 215.

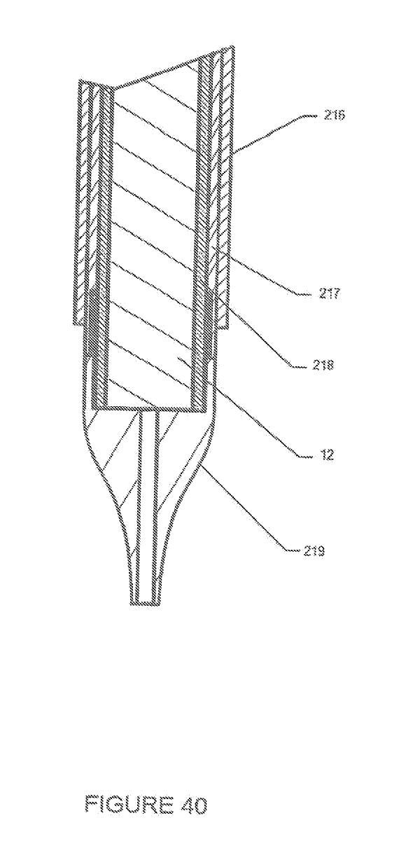

Turning to FIG. 40, depicted is detail of a transverse cross sectional view of a cartridge housing 217 and extruding conduit tip 219 assembly wherein a heating band 216 is depicted as a beating band surrounding the cartridge housing 217 functioning to heat the functional substance 12. In such an embodiment, the heating band may accept electrical communication and power from an external source or may receive electrical communication and power from an onboard element. In alternative embodiments, the heater band 216 may be integral to housing 217 or may be manually removable. In an alternative embodiment, the heater band may provide heat through a chemical process or be first heated by an external source and provide a quantity of heat to the interior components for time thereafter.

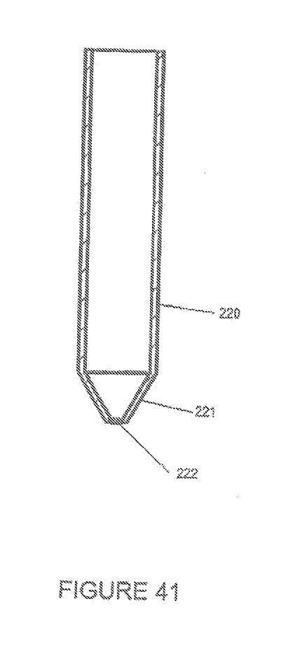

Turning to FIG. 41, depicted is a transverse cross sectional view of an embodiment of an exchangeable cartridge casing having a main casing section 220, a tapered casing section 221, and an open end 222. In such an embodiment, the cartridge itself may contain a functional substance and in addition provide a reduced section for directly extruding the functional substance without necessitating an additional extrusion conduit tip.

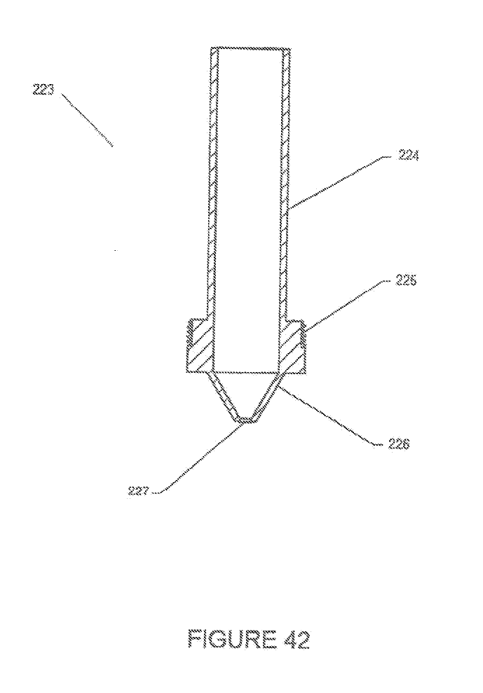

Turning to FIG. 42, depicted is a transverse cross sectional view of an embodiment of a cartridge 223 having an integral cartridge retaining element 225, which is depleted with threads; a cartridge casing 224; an integral tapered extrusion conduit tip section 226; and an extrusion conduit flow channel 227.

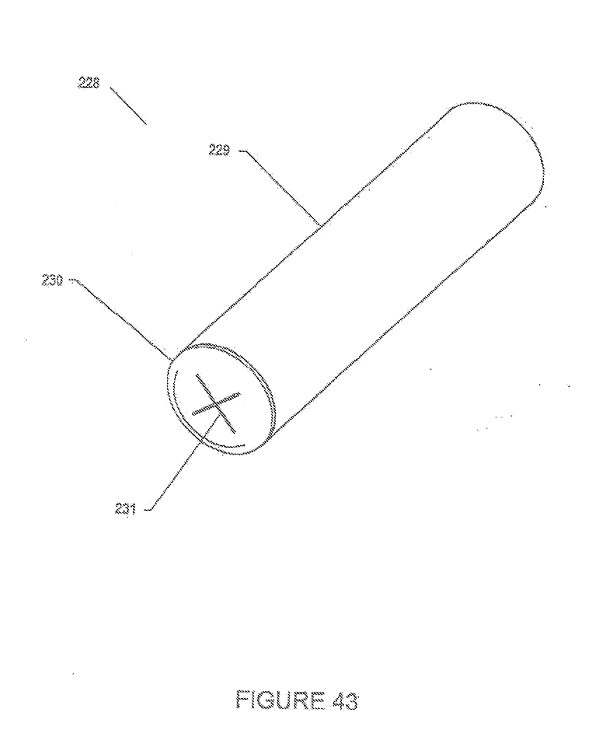

Turning to FIG. 43, depicted is a proximal end perspective view of an embodiment of a cartridge 228; composed of a cartridge casing 229, a resistive cross-slit valve 230 fixed to the proximal end of the cartridge casing having slits 231.

While the invention has been described with respect to certain embodiments, as will be appreciated by those skilled in the art, it is to be understood that the invention is capable of numerous changes, modifications and rearrangements, and such changes, modifications and rearrangements are Intended to be covered by the following claims.

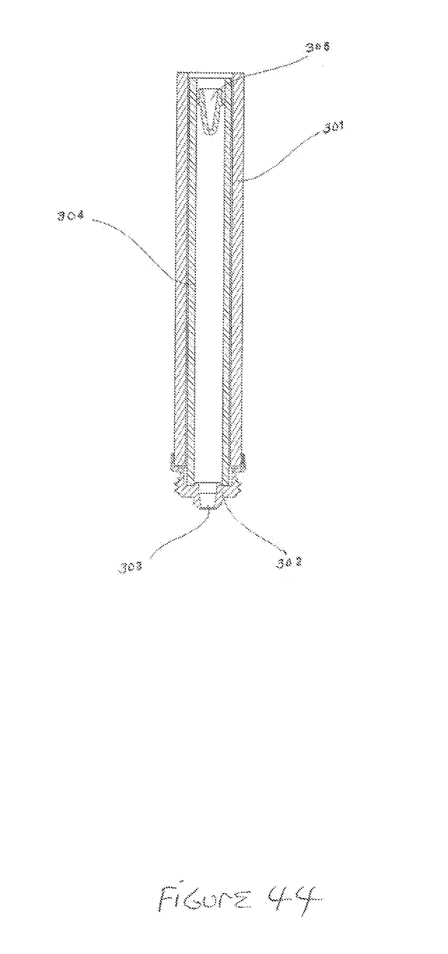

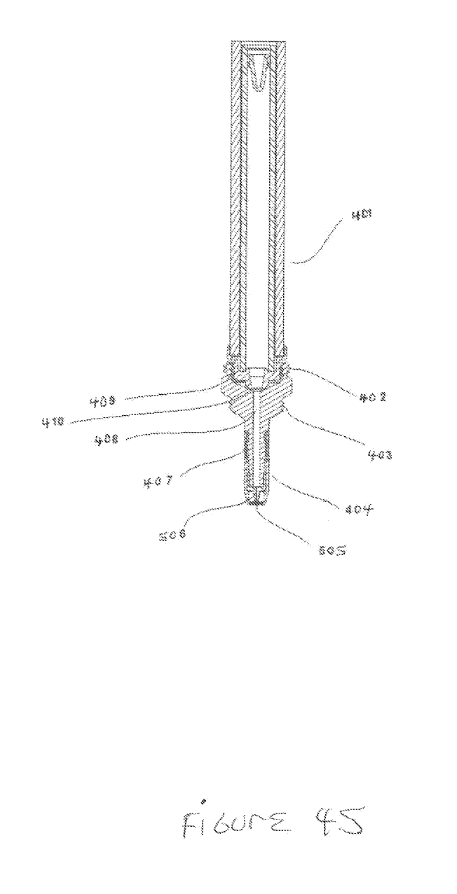

Referring now to FIGS. 44 and 45, there is shown 301 protection casing surrounding the internal reservoir, operatively linked to 302—proximal cart tip with threaded extrusion tip retaining element, and 303 extrusion conduit with 304 functional substance reservoir and 305 plunger plug. Finally, those skilled in the art understand further modifications, including the below as described and claimed herein.

Likewise, 401 Cartridge with proximal retaining element retained to extrusion tip with threads, with 402 threads on extrusion tip for retaining to cart housing, 403 threads on extrusion tip for retaining a cover cap with threads 404 extrusion tip section for retaining duckbill flow control valve 405 with threaded interface (505 general extrusion pod of the extrusion tip, 506 elastomeric flow control duckbill valve) and 408—fluid flow conduit, 409 interfacing threads of extrusion tip and cartridge proximal retaining element along with 410—sealing interface of extrusion tip and cartridge fluid flow conduit.

What is claimed is:

1. A device for dispensing a metered amount of a functional substance, the device comprising:
a cartridge housing having a proximal end, a distal end, and an internal bore, the cartridge housing configured to house an exchangeable cartridge including a cartridge plug and a functional substance;
an extruding conduit tip at the proximal end of the cartridge housing, the tip comprising a fluid flow conduit; and
an advancing member configured to fit into the internal bore and configured to move axially through the bore; and
wherein, when the advancing member moves towards the proximal end of the housing, it forces a metered amount of the functional substance through the extruding conduit tip.

2. The device of claim 1, wherein the advancing member comprises a manual manipulation member.

3. The device or claim 2, wherein the manual manipulation member comprises a finger grip configured to move the advancing member through the internal bore when slid proximally.

4. The device of claim 1, wherein the advancing member comprises a plunger.

5. The device of claim 4, wherein the plunger is a rod.

6. The device of claim 4, wherein the plunger is a screw.

7. The device of claim 6, further comprising a multi-lobed bed pin and a coil spring configured to provide pressure against the multi-lobed pin; and wherein the manual manipulation member comprises a manually rotatable element configured to advance the plunger through the internal bore when rotated.

8. The device of claim 1, wherein the cartridge comprises a functional substance, a plunger plug, and a fluid control valve.

9. The devise of claim 1, further comprising a cartridge plug coupled to the plunger, the plug configured to establish a seal wish the internal diameter of the internal bore and to push the functional substance through a fluid control valve when the plunger is advanced.

10. The device of claim 1, further comprising a cartridge viewing slot.

11. The device of claim 1, further comprising a proximal cap.

12. The device of claim 1, wherein the extruding conduit tip further comprises a fluid control valve.

13. The device of claim 12, wherein the fluid control valve is a one-way valve.

14. The device of claim 1, further comprising an advanceable stop.

15. The device of claim 14, wherein the advanceable stop comprises an axial bore and the advancing member extends through the axial bore.

16. The device of claim 14, wherein the advanceable stop limits the movement of the advancing member relative to the position of the advanceable stop.

17. The device of claim 14, wherein the advanceable stop comprises a helical thread configured to engage with a helical thread on the cartridge housing, and whereby rotation of the advanceable stop causes the advanceable stop to move axially relative to the cartridge housing.

18. The device of claim 14, wherein the cartridge housing comprises a first graduated scale.

19. The device of claim 18, wherein a 360-degree turn of the advanceable stop causes the advanceable stop to move axially relative to the cartridge housing a distance of one unit of the first graduated scale.

20. The device of claim 19, wherein the advanceable stop comprises a second graduated scale.

21. The device of claim 20, wherein the second graduated scale is situated circumferentially around the advanceable stop.

22. The device of claim 21, wherein the second graduated scale comprises fractions of the first graduated scale, such that a partial rotation of the advanceable stop indicates a fractional advancement of the advanceable stop with respect to the first graduated scale.

23. The device of claim 1, further comprising a second cartridge housing substantially similar to the first cartridge housing, wherein each cartridge housing is configured to house an exchangeable cartridge and allow independent dispensing of functional substances therein.

24. The device of claim 23, wherein the functional substances of the exchangeable cartridges are mixed prior to expulsion through the extruding conduit tip.

25. The device of claim 1, wherein the advancing member is in electrical communication with an electronic control circuit and an electric motor.

26. The device of claim 25, wherein the advancing member is configured to be controlled electronically.

27. The device of claim 26, wherein the advancing member can be controlled by a remote operator.

28. The device of claim 27, wherein the device is configured to deliver a metered amount of one or more functional substances, the metered amount being predetermined by the remote operator.

29. The device of claim 1, wherein the advancing member is controlled by pressure provided by a pneumatic system.

30. The device of claim 1, further comprising an electronic heating element.

31. A device for dispensing a metered amount of a functional substance, the device comprising:
a housing having a proximal end, a distal end, and an internal bore, the housing configured to contain a functional substance;
an advancing member configured to fit into the internal bore and configured to move axially through the bore; and
an advanceable stop configured to move axially relative to the housing and block the advancing member's movement through the internal bore, based on the advanceable stop's position relative to the housing; and
wherein, when the advancing member moves towards the proximal end of the housing, it forces a metered amount of the functional substance out of the proximal end, the metered amount determined by the position of the advanceable stop relative to the housing.

32. The device of claim 31, wherein the advanceable stop comprises a helical thread configured to engage with a helical thread on the housing, and whereby rotation of the advanceable stop causes the advanceable stop to move axially relative to the housing.

33. The device of claim 31, wherein the housing comprises a first graduated scale.

34. The device of claim 33, wherein a 360-degree turn of the advanceable stop causes the advanceable stop to move axially relative to the cartridge housing a distance of one unit on the first graduated scale.

35. The device of claim 34, wherein the advanceable stop comprises a second graduated scale.

36. The device of claim 35, wherein the second graduated scale is situated circumferentially around the advanceable stop.

37. The device of claim 36, wherein the second graduated seals comprises fractions of the first graduated scale, such that a partial rotation of the advanceable stop indicates a fractional advancement of the advanceable stop with respect to the first graduated scale.

38. A device for dispensing a metered amount of a functional substance, the device comprising:
a cartridge housing having a proximal end, a distal end, and an internal bore, the cartridge housing configured to house an exchangeable cartridge containing a cartridge plug and a functional substance;
an extruding conduit tip at the proximal end of the cartridge housing, the tip comprising a fluid flow conduit; and
an advancing member comprising an advanceable screw threaded through an internal threaded opening in the cartridge housing and coupled to a rotatable element at the distal end of the cartridge housing; and
wherein, when the advancing member moves towards the proximal end of the housing, it forces a metered amount of the functional substance through the extruding conduit tip.

39. The device of claim 38, wherein the cartridge comprises a functional substance, a plunger plug, and a fluid control valve.

40. The device of claim 38, further comprising a cartridge plug coupled to the plunger, the plug configured to establish a seal with the internal diameter of the internal bore and to push the functional substance when the plunger is advanced.

41. The device of claim 38, further comprising a cartridge viewing slot.

42. The device of claim 38, further comprising a proximal cap.

43. The device of claim 38, further comprising a second cartridge housing substantially similar to the first cartridge housing, wherein each cartridge housing is configured to house an exchangeable cartridge, and allow independent dispensing of functional substances therein.

44. The device of claim 43, wherein the functional substances of the exchangeable cartridges are mixed prior to expulsion through the extruding conduit tip.

45. The device of claim 38, wherein the advancing member is in electrical communication with an electronic control circuit and an electric motor.

46. The device of claim 45, wherein the advancing member is configured to be controlled electronically.

47. The device of claim 46, wherein the advancing member can be controlled by a remote operator.

48. The device of claim 47, wherein the device is configured to deliver a metered amount of one or mere functional substances, the metered amount being predetermined by the remote operator.

49. The device of claim 38, wherein the advancing member is controlled by pressure provided by a pneumatic system.

50. The device of claim 38, further comprising a visual graduated scale.

51. The device of claim 38, wherein the extruding conduit tip further comprises a fluid control valve.

52. The device of claim 51, wherein the fluid control valve is a one-way valve.

53. The device of claim 38, further comprising an electronic heating element.

54. A method of dispensing a metered amount of a functional substance, the method comprising:
providing a device for dispensing a metered amount of a functional substance, the device comprising:
a cartridge housing comprising an internal bore;
an advancing member; and
an advanceable stop; and
inserting an exchangeable cartridge containing a functional substance into the device;
moving the advancing member a measured distance through the internal bores thereby forcing a metered amount of functional substance cut of the device.

55. The method of claim 54, wherein the plunger is advanced manually.

56. The method of claim 54, wherein the plunger is advanced electronically.

57. The method of claim 54, wherein the plunger is advanced by pressure provided by a pneumatic system.

58. The method of claim 54, wherein measured distance is defined by a visible graduated scale.

59. The method of claim 54, further comprising adjusting the advanceable stop to a position relative to the advancing member wherein the advanceable step limits the range of movement of the advancing member, thereby limiting the amount of functional substance expelled from the device.

60. A method of controlling an electronic dispensing device, the method comprising:
providing a device for dispensing a metered amount of a functional substance; and
sending an electronic signal to the device, the signal comprising dosage information for one or more substances, wherein the electronic signal limits the device to dispensing only the one or more substances in the dosage indicated.

61. The method of claim 60, wherein the device comprises a first cartridge housing configured to house an exchangeable cartridge comprising a functional substance.

62. The method of claim 61, wherein the device further comprises a second cartridge housing substantially similar to the first cartridge housing.

63. The method of claim 62, further comprising dispensing two or more functional substances independently of each other.

64. The method of claim 63, further comprising mixing two or more functional substances prior to dispensing the substances.

65. The method of claim 60, wherein the signal is sent via remote operation.

66. The method of claim 65, wherein the signal is sent by a medical professional.

67. A device comprising:
a cartridge having a proximal and a distal end;
a functional substance contained within the cartridge;
a plunger plug at the distal end; and
a fluid control valve at the proximal end.

68. The device of claim 67, wherein the plunger plug is configured to be pushed proximally through the cartridge, thereby expelling functional substance through the fluid control valve.

69. The device of claim 68, wherein the fluid control valve is configured to open in response to a pressure inside the cartridge and close when the pressure is relieved.

70. The device of claim 67, wherein the fluid control valve is a one-way valve.

71. The device of claim 67, wherein the fluid control valve is bidirectional.
